(19) United States
(12) Patent Application Publication
(10) Pub. No.: US 2007/0050526 A1
(43) Pub. Date: Mar. 1, 2007

(54) Storage control device and separation-type storage device

(75) Inventors: Tetsuya Abe, Fujisawa (JP); Akira Murotani, Odawara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/261,766

(22) Filed: Oct. 31, 2005

(30) Foreign Application Priority Data
Aug. 31, 2005 (JP) 2005-251196

(51) Int. Cl. G06F 13/12

(52) U.S. Cl. 710/68

(57) ABSTRACT

According to the present invention, a portion of the storage control device is configured as a detachable separation-type storage bay and a large volume of data can be moved altogether by transporting the storage bay. The separation-type storage bay is detachably provided in the device main body of the storage control device. The storage bay comprises a plurality of disk drives. When a backup of the primary volume is created, a secondary volume is created in the storage bay and data is copied. The storage bay is removed from the device main body by the user and attached to a backup storage control device. The backup storage control device recognizes the storage configuration of the storage bay by acquiring management information when the storage bay is attached to the backup storage control device. The backup storage control device reads the backup data from the storage bay and stores the backup data in the backup device.

### CROSS-REFERENCE TO RELATED APPLICATIONS

This application relates to and claims priority from Japanese Patent Application No. 2005-251196 filed on Aug. 31, 2005, the entire disclosure of which is incorporated herein by reference.

### BACKGROUND OF THE INVENTION

1. Field of the Invention

The present invention relates to a storage control device and separation-type storage device.

2. Description of the Related Art

The storage control device is able to provide a host computer (‘host’ hereinbelow) with high-capacity and high-performance storage services. In a storage control device, for example, a multiplicity of disk drives is arranged in the form of an array and storage areas are constructed on the basis of RAID (Redundant Array of Independent Disks). A logical volume (LU: Logical Unit) constituting a logical storage area is established on a physical storage area that each disk drive comprises. The host is able to read and write data with respect to the logical volume.

The storage control device stores and manages a large volume of various data groups that are used by a variety of institutions such as enterprises, municipalities, or universities, for example. Such data groups are stored at predetermined intervals in accordance with laws and independent regulations.

Further, a backup site can be installed in places far apart from the main site provided for a disaster extending over a large area as is known for so-called disaster recovery. A backup secondary storage control device is installed on the backup site. The stored content of the secondary storage control device is suitably synchronized with the stored content of the primary storage control device of the main site (Japanese Patent KOHYO Publication No. H8-509565). In this technology, the update data written to the primary volume is transmitted to the secondary volume via a high-speed communication link and the stored content of the primary and secondary volumes is matched.

Further, for example, a method in which the stored content of the storage control device of the main site is copied to a magnetic tape and introduced to the backup site so that the stored content of the tape is reflected by the storage control device of the backup site is also known.

Further, a technology that involves replacing the disk drive in an enclosure and installing the disk drive in another enclosure is also known (Japanese Patent Application Laid Open No. 2001-337792) With this technology, information relating to the insertion position is stored in the disk drive and, when the disk drive is remounted in the enclosure, information relating to the position is read and the disk controller corrects the mapping.

When the stored content of the main site and the stored content of the backup site are synchronized, the stored content of the main site at a certain point in time is first copied to the backup site for each disk by performing initial copying (established copying). Thereafter, data that is updated at the main site is transferred via a network to the backup site as differential data to update the stored content of the backup site.

However, when a communication line is used, the bandwidth and speed of the communication line differ depending on the data size or the like of the copy target, and the data transfer requires a long time. When a plurality of dedicated high-speed communication lines are used, the data transfer time can also be shortened, but the usage material of the communication lines increases and the running costs rise.

In a method that involves backing up the data of the main site to magnetic tape to introduce the data to the backup site, a communication line ends up not being used. However, the data write speed and data read speed of the tape device are slow in comparison with those of the disk drive, the time taken to copy the data of the primary volume to the magnetic tape and the time taken to copy the data of the magnetic tape to the secondary volume are long, and user convenience is therefore low.

A case where only a volume backup is made also produces similar problems. When a backup is made to a magnetic tape with a low access speed, the backup creation time is extended. Further, the restore time also increases when backup data stored on magnetic tape is restored to a volume. Therefore, when magnetic tape is used, user convenience is low.

Further, the abovementioned Japanese Patent Application Laid Open No. 2001-337792 also discloses a method that involves installing a disk drive in another enclosure. However, Japanese Patent Application Laid Open No. 2001-337792 only discloses a method for moving original disk drives individually. Therefore, the collective and simultaneous transfer of data scattered over a high-capacity disk drive to another enclosure is not considered at all.

### SUMMARY OF THE INVENTION

The present invention was conceived in view of the above problems and an object of the present invention is to provide a storage control device and separation-type storage device that make it possible to construct a backup site at an early stage. A further object of the present invention is to provide a storage control device and separation-type storage device that make it possible to move data stored in a plurality of storage drives altogether in a state where the data is still stored in a storage drive without the involvement of a communication network. Further objects of the present invention will become evident from the subsequent description of the embodiments.

In order to solve the above problem, a storage control device according to one aspect of the present invention comprises a device main body connected to an external device and a storage device provided in the device main body. The storage device is configured as a separation-type storage device that is detachably attached to the device main body. Further, (1) the device main body comprises a first control portion for controlling the exchange of data between the storage device and the external device; a first memory portion that is used by the first control portion and which stores management information for managing the storage device; and a first connection portion for a connection with the separation-type storage device. Further, (2) the separation-type storage device comprises a plurality of storage drives; a second control portion that controls the exchange of data between each of the storage drives; a second memory portion that is used by the second control portion and which stores the management information; and a second connection portion for a connection with the device main body via the first connection portion.

Here, it should be noted that the separation-type storage device contains a plurality of storage drives, comprises a second control portion that controls the transfer of data to and from each of the storage drives, and holds management information.

According to one embodiment, the management information is configured including configuration information relating to each of the storage drives and configuration information relating to a logical volume that is generated on the basis of each storage area of each of the storage drives. Configuration information relating to each storage drive can include information for identifying each of the storage drives and information for identifying a RAID group configured by each storage drive, and so forth, for example. Configuration information relating to logical volumes can include information for identifying each of the logical volumes and information indicating the status of each logical volume, for example.

In one embodiment, at least a portion of the management information stored in the second memory portion is rewritten by the first control portion in both a case where the separation-type storage device is removed from the device main body and a case where the separation-type storage device is attached to the device main body.

In one embodiment, when the separation-type storage device is attached to the device main body, the first control portion resets identification information for identifying each of the storage devices and identification information for identifying a logical volume that is generated on the basis of the respective storage areas of each of the storage devices, and rewrites the management information stored in the first memory portion and the second memory portion. As a result, when the separation-type storage device is mounted in the device main body, the storage control device is able to coordinate the positions of each logical volume and each storage drive within the storage control device.

In one embodiment, the management information includes access control information for controlling access to the logical volume. The access control information can be set so that writing to a logical volume is prohibited. By prohibiting writing to a logical volume, the separation-type storage device can be used as a backup device. As a method for prohibiting writing to a logical volume, the setting of the statuses of ‘write control (write prohibition)’, ‘access prohibition (volume locking)’ and ‘empty capacity 0’, for example, for the logical volume may be considered.

In one embodiment, the device main body comprises a built-in storage device that differs from the separation-type storage device and the built-in storage device and the separation-type storage device are associated by means of the management information. The built-in storage device is contained in the device main body and can be configured comprising a plurality of storage drives. The built-in storage device differs from the separation-type storage device and is, as a general rule, not detachable from the device main body. For example, as per the relationship between a copy source volume and copy destination volume, the separation-type storage device and built-in storage device are associated by means of management information.

In one embodiment, the device main body comprises another logical volume that differs from the logical volume that the separation-type storage device comprises; the logical volume of the separation-type storage device and the other logical volume are associated by means of the management information; and the first control portion is able to move data between each of the logical volumes.

In one embodiment, the first control portion is able to perform volume copying with the other logical volume serving as the copy source volume and the logical volume of the separation-type storage device serving as the copy destination volume; and the management information includes generation management information for managing the generation of data that is stored in the logical volume of the separation-type storage device. As a result, plural generation backups can be managed by the separation-type storage device and data of a predetermined generation can be restored by the storage control device.

In one embodiment, the management information includes volume status information indicating the status of the logical volume; and the volume status information includes a first split state that indicates a split state in a case where the separation-type storage device and the device main body are physically connected and a second split state that indicates a split state in a case where the physical connection between the separation-type storage device and the device main body is cancelled.

In one embodiment, the separation-type storage device comprises a self diagnostics portion for diagnosis of the state of each of the storage drives; and a third connection portion for a connection with an instruction device, wherein the self diagnostics portion diagnoses the state of each of the storage drives on the basis of an instruction from the instruction device.

In one embodiment, the self diagnostics portion generates and stores compression information for the data that is written from the first control portion to each of the storage drives via the second control portion, and verifies the reliability of the data by comparing the compression information that is generated once again from the data stored in each of the storage drives with the stored compression information.

In one embodiment, the separation-type storage device comprises a user interface portion and the separation-type storage device is able to execute control operations of a plurality of types on the basis of an instruction from the user interface portion.

In one embodiment, the separation-type storage device comprises a third connection portion that can be connected directly to another separation-type storage device via the second connection portion without involving the device main body and which allows a connection with an instruction device; and the second control portion erases data that is stored in each of the storage drives and the management information that is stored in the second memory portion on the basis of an instruction from the instruction device. Further, as in a case where the separation-type storage device is provided with an erase switch, an instruction device can also be integrated into the separation-type storage device.

In one embodiment, the separation-type storage device comprises a third connection portion that can be connected directly to another separation-type storage device without involving the device main body and which allows a connection with an instruction device, and the second control portion transfers data stored in each of the storage drives to the other separation-type storage device and causes the other separation-type storage device to store the data on the basis of an instruction from the instruction device. Here, upon receiving an instruction from the instruction device, the second control portion is able to request predetermined certification information from the instruction device and perform processing based on the instruction only when certification is successful. As a result, it is possible to suppress the incorrect extraction to the outside of the data stored in the separation-type storage device.

In one embodiment, the external device is at least one of a higher order device that reads and writes data to each of the storage drives or a backup device that stores data stored in each of the storage drives. That is, a first storage control device that is connected to a high-order device and a second storage control device that is connected to a backup device, for example, are provided and data stored by the first storage control device is copied to the separation-type storage device and the separation-type storage device is attached to the second storage control device, whereby data can be transferred to a backup medium such as a tape device. Further, similarly, by using a separation-type storage device, data stored in a plurality of storage drives can be moved altogether and at once between a plurality of storage control devices. As a result, following completion of initial copying between a plurality of storage control devices, differential data alone can be transferred via a communication network to the copy-destination storage control device in order to allow the stored content of both storage control devices to be synchronized.

The separation-type storage device according to a further aspect of the present invention is a separation-type storage device that is detachably attached to a storage control device connected to an external device, comprising: an enclosure; a plurality of storage drives provided in the enclosure; a second connection portion for a connection to the storage control device via a first connection portion that is provided in the device main body of the storage control device; a second control portion that is connected via the first and second connection portions to a first control portion provided in the device main body and which controls the exchange of data between each of the storage drives; and a second memory portion that stores management information for managing each of the storage drives.

In one embodiment, the separation-type storage device further comprises a third connection portion for a direct connection with an instruction device, wherein the second control portion executes a predetermined control operation on the basis of an instruction that is input from the instruction device via the third connection portion.

In one embodiment, the predetermined control operation includes an erasure operation for erasing data that is stored in each of the storage drives and the management information that is stored in the second memory portion, and an output operation that outputs data stored in each of the storage drives to the outside.

At least some of the means, functions, and steps of the present invention can sometimes be configured as a computer program that is read and executed by a microcomputer. Such a computer program can be distributed by being fixed on a storage medium such as a hard disk or optical disk or the like, for example. Alternatively, a computer program can also be supplied via a communication network such as the Internet.

### BRIEF DESCRIPTION OF THE DRAWINGS

FIG. 1 is an explanatory view of the overall outline of an embodiment of the present invention;

FIG. 2 is an explanatory view of the overall configuration of a storage system;

FIG. 3 is a front view of a separation-type storage bay;

FIG. 4 is a perspective view of a separation-type storage bay;

FIG. 5 is a block diagram of the storage control device;

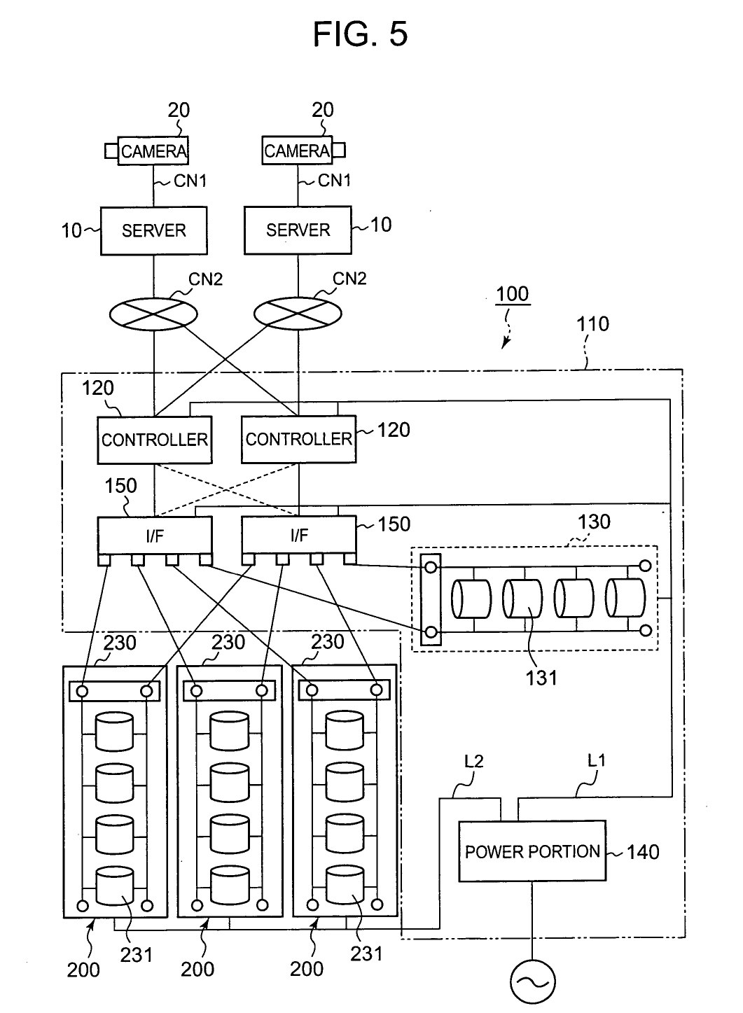

FIG. 6 is an explanatory view of the configuration of the mechanical connection between the device main body and separation-type storage bay, where FIG. 6A shows the state where the separation-type storage bay is attached to the device main body and FIG. 6B shows a state where the separation-type storage bay has been removed from the device main body;

FIG. 7 is a block diagram of the device main body;

FIG. 8 is a block diagram of the separation-type storage bay;

FIG. 9 is an explanatory view of a volume correspondence table;

FIG. 10 is an explanatory view of the relationship between the built-in storage bay of the device main body and the separation-type storage bay;

FIG. 11 is an explanatory view of the relationship between the volumes stored in the separation-type storage bays and the disk drive;

FIG. 12 is an explanatory view of an LU management table;

FIG. 13 is an explanatory view of genealogy information stored in the device main body;

FIG. 14 is an explanatory view of first genealogy information that is stored in the separation-type storage bay;

FIG. 15 is an explanatory view of second genealogy information that is stored in the separation-type storage bay;

FIG. 16 is a flowchart showing the processing when the separation-type storage bay is removed from the device main body;

FIG. 17 is a schematic view of a case where self-diagnostic processing is performed by supplying power to the separation-type storage bay, where FIG. 17A shows a case where self-diagnostic processing is performed independently on the separation-type storage bay and FIG. 17B shows a case where self-diagnostic processing is performed in cooperation with a management terminal;

FIG. 18 is a flowchart showing a case where self-diagnostic processing is performed independently on the separation-type storage bay;

FIG. 19 is a flowchart of a case where the self-diagnostic processing is performed in cooperation with a management terminal;

FIG. 20 is an explanatory view of a terminal screen for the self-diagnostic processing;

FIG. 21 is a flowchart of processing in which data falsification is detected and falsified data is repaired;

FIG. 22 is an explanatory view of an aspect in which data is copied directly between a plurality of separation-type storage bays;

FIG. 23 is a flowchart showing processing in which data is copied directly between a plurality of separation-type storage bays;

FIG. 24 is a flowchart showing processing in which content stored in the separation-type storage bay is erased altogether without using the management terminal;

FIG. 25 is a flowchart showing processing in which a separation-type storage bay is connected to the device main body;

FIG. 26 is a state transition diagram for the separation-type storage bay; and

FIG. 27 is an explanatory view of an outline of a storage system pertaining to a second example.

### DESCRIPTION OF THE PREFERRED EMBODIMENTS

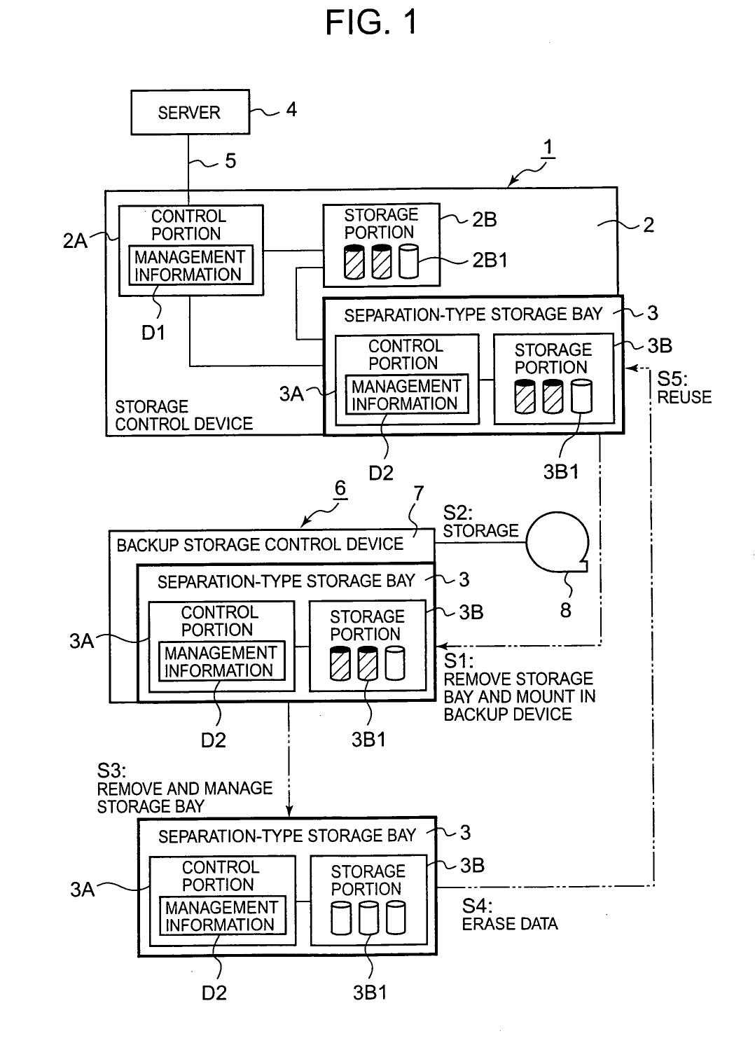

An embodiment of the present invention will be described hereinbelow with reference to the drawings. FIG. 1 is an explanatory view of the overall outline of this embodiment. A storage system can be configured comprising a storage control device 1, server 4, and backup storage control device 6, for example.

The storage control device 1 is a device for storing data that is used by the server 4 and is configured as a disk array device, for example. The storage control device 1 can be broadly classified as a device main body 2 and a separation-type storage bay that is detachably mounted in the device main body 2. The device main body 2 can comprise a control portion 2A and a storage portion 2B, for example.

The control portion 2A is connected to the server 4 via a communication network 5. Communication network 5 can be a SAN (Storage Area Network), LAN (Local Area Network), or the like, for example. The control portion 2A processes an access request from the server 4, writes user data to a predetermined disk drive, or transmits requested data to server 4. Further, the control portion 2A holds management information D1 for using the storage portion 2B and a separation-type storage bay 3. Management information D1 can be stored in memory provided in the control portion 2A or stored in a predetermined storage area of the storage portion 2B.

The storage portion 2B comprises a plurality of disk drives 2B1. Disk drives can include hard disk drives, semiconductor memory drives, optical disk drives, magnetic optical disks and so forth. The storage portion 2B differs from the separation-type storage bay 3 and is not normally removed from the device main body 2. The storage portion 2B is therefore also known as the built-in storage portion 2B. However, this does not mean that the storage portion 2B is undetachably fixed to the device main body 2. For example, when maintenance work is performed, the storage portion 2B can be removed from the device main body 2.

The separation-type storage bay 3 comprises a control portion 3A and a storage portion 3B, for example. The control portion 3A performs data exchange with the storage portion 3B. The control portion 3A holds management information D2. Similarly, the management information D2 can be stored in memory that is located inside or outside the control portion 3A or in a predetermined storage area of the storage portion 3B. Management information D2 is generated on the basis of management information D1 and is updated by the control portion 2A. Like the storage portion 2B, the storage portion 3B comprises a plurality of disk drives 3B1.

Thus, the separation-type storage bay 3 comprises an independent drive control function and a plurality of disk drives 3B1 and is configured as a simple disk array device. However, unlike the storage control device 1, the separation-type storage bay 3 is unable to supply services directly to the server 4. That is, server 4 is able to use the storage portion 3B of the separation-type storage bay 3 via the device main body 2 of the storage control device 1.

The backup storage control device 6 is a device for backing up data. Similarly to the storage control device 1, the backup storage control device 6 can be configured comprising a device main body 7 and the separation-type storage bay 3 that is detachably connected to the device main body 7. The device main body 7 comprises a control portion and a built-in storage portion. Stated simply, the backup storage control device 6 is configured through the connection of the backup device 8 to the storage control device 1. Therefore, the separation-type storage bay 3 can be mounted in the backup storage control device 6. Examples of the backup device 8 can include a magnetic optical disk, hard disk drive, and so forth, for example.

An outline of the overall operation will be described next. The server 4 accesses a primary volume that is supplied by the storage portion 2B via the communication network 5 and reads and writes data. When a backup of the primary volume is created, a secondary volume is created within the storage portion 3B of the separation-type storage bay 3. Further, data copying from the primary volume to the secondary volume is performed within the storage control device 1 without involving the server 4.

When a data backup is complete, the separation-type storage bay 3 is removed from the device main body 2 by a user such as a system administrator. The built-in storage portion 2B still remains in the device main body 2 following removal of the separation-type storage bay 3. Therefore, server 4 is able to read and write data both during the creation of backup data and following creation of backup data.

Further, the separation-type storage bay 3 removed from the device main body 2 is attached to the device main body 7 of the backup storage control device 6 by the user (S1). The backup storage control device 6 may be installed on the same site as the storage control device 1 or installed on other site. The separation-type storage bay 3 can be made small and lightweight in comparison with the storage control device 1. Therefore, the separation-type storage bay 3 can also be transported to a remote site by using transportation means such as a train, automobile or airplane, for example.

When the separation-type storage bay 3 is attached, the backup storage control device 6 acquires the management information D2 and recognizes the storage configuration of the separation-type storage bay 3. Examples of the storage configuration can include the physical configuration relating to the quantity and addresses (positions) of physical drives and the logical configuration such as the quantity and addresses (positions) of logical volumes, for example. Upon recognizing the configuration of the separation-type storage bay 3, the backup storage control device 6 reads the backup data stored in the separation-type storage bay 3. The backup storage control device 6 stores the backup data thus read in the backup device 8 (S2).

Upon completion of data copying to the backup device 8, the user removes the separation-type storage bay 3 from the device main body 7 of the backup storage control device 6 (S3). The user then erases the backup data that is stored in the separation-type storage bay 3 (S4). Here, the management information D2 can be erased together at the same time as the data erasure.

The separation-type storage bay 3 from which data have been erased is transported to a site where the storage control device 1 is provided and then re-attached to the device main body 2 (S5) As a result, the separation-type storage bay 3 is re-used.

Thus, in this embodiment, a portion of the storage control device 1 is configured as the separation-type storage bay 3 and is detachably provided. Therefore, the separation-type storage bay 3 can be configured relatively small and lightweight and only the separation-type storage bay 3 can be removed from the storage control device 1 and transported to another location. For this reason, data that has been stored in a plurality of disk drives 3B1 can be transported together and this data can be used simply at the transportation destination.

This embodiment is configured such that data can be copied from the storage portion 2B in the device main body 2 to the storage portion 3B of the separation-type storage bay 3. Therefore, for example, by preparing a plurality of separation-type storage bays 3, backups of each generation can be generated. Further, data can be copied at a relatively high speed between each of the disk drives 2B1 and 3B1.

In this embodiment, data that is stored in the storage control device 1 can be copied to the separation-type storage bay 3 and the separation-type storage bay 3 can be transported for use in another location. Therefore, by performing initial copying by using the separation-type storage bay 3, the backup site can be rapidly constructed without using a communication network. Further, the differential data produced following completion of initial copying may be transmitted via a communication network. This embodiment will be described in more detail hereinafter.

### EXAMPLE 1

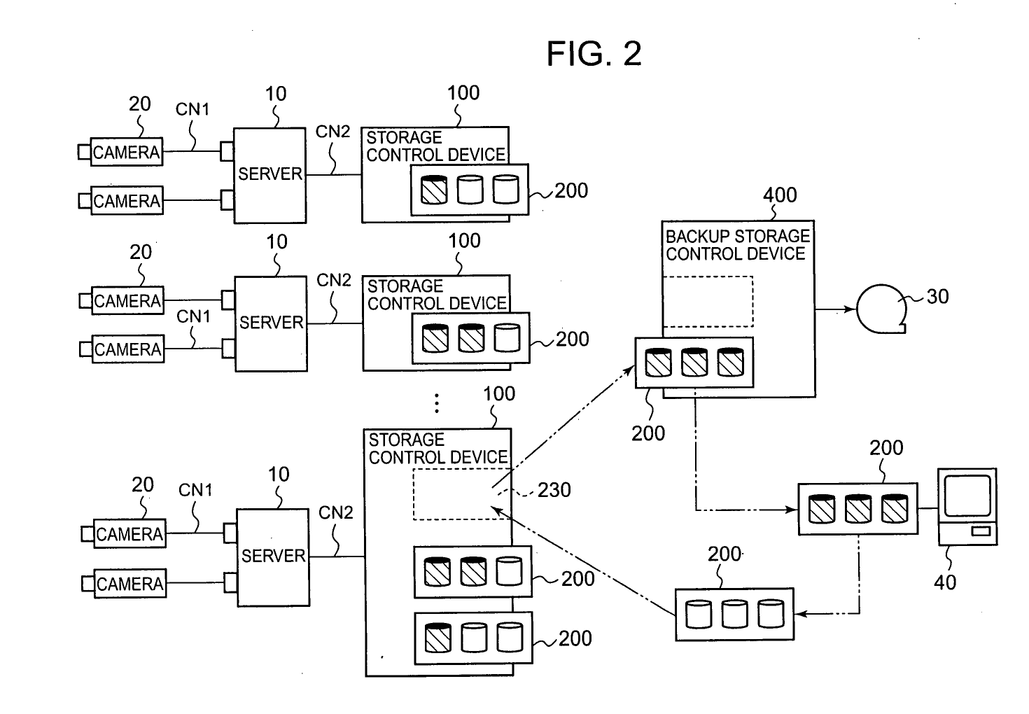

FIG. 2 is a perspective view showing the overall configuration of a storage system that uses the storage control devices 100 and 400 according to the present invention. This storage system is used as a part of the monitoring system, for example. When the relationship of correspondence with FIG. 1 is described first, a server 10 corresponds with server 4 in FIG. 1, the storage control device 100 corresponds with the storage control device 1 in FIG. 1, the separation-type storage bay 200 corresponds with the separation-type storage bay 3 in FIG. 1, the backup storage control device 400 corresponds with the backup storage control device 6 in FIG. 1, and the backup device 30 corresponds with the backup device 8 in FIG. 1.

A surveillance camera 20 is installed on each floor of the building, a plurality of stores, and in a plurality of offices. Each surveillance camera 20 images the scenery of the physical world in predetermined cycles and outputs the image data to the server 10. The server 10 receives image data from each camera 20 and stores the image data in the storage control device 100 as is of after suitably subjecting the image data to compression processing.

The server 10 can be provided on each floor and in each store or provided on a plurality of floors or in a plurality of stores. Similarly, the storage control device 100 may be provided in each server 10 or provided in each of a plurality of servers.

Further details will be provided subsequently but the storage control device 100 comprises one or a plurality of bay slots 230 and the separation-type storage bay 200 is detachably provided in the bay slots 230. The storage control device 100 can comprise one or a plurality of separation-type storage bays 200. FIG. 2 shows both a storage control device 100 that comprises one storage control device 200 and a storage control device 100 that comprises a plurality of separation-type storage bays 200.

Further, so too in a case where a plurality of bay slots 230 are provided, separation-type storage bays 200 need not be mounted in all the bay slots. Further, when the storage control device 100 comprises a built-in storage bay, even when only one separation-type storage bay 200 is installed, the storage control device 100 is able to process an access request from the server 10.

The data stored in the storage control device 100 is copied to the separation-type storage bay 200. The copying is performed within the storage control device 100 and does not affect the server 10. When a backup is made, the separation-type storage bay 200 is removed from the storage control device 100 and is attached to the backup storage control device 400. The backup storage control device 400 comprises a similar configuration to that of the storage control device 100 with regard to the attachment of the separation-type storage bay 200. The backup device 30 such as a magnetic optical device, for example, is connected to the backup storage control device 400.

The data that is stored in the separation-type storage bay 200 is copied to the backup device 30 via the backup storage control device 400. When data copying is complete, the separation-type storage bay 200 is removed from the backup storage control device 400.

Further, the separation-type storage bay 200 is connected to the management terminal 40. The management terminal 40 can be configured as a computer terminal such as a notebook-type personal computer, portable information terminal or cellular phone, for example. A user such as a system administrator is able to connect the management terminal 40 to the separation-type storage bay 200 and supply commands to the separation-type storage bay 200. For example, the user is able to issue a data erasure instruction. Upon receiving a command ordering data erasure, the separation-type storage bay 200 erases all the data and/or management information that have been stored.

When all the data and management information stored in the separation-type storage bay 200 is erased, the separation-type storage bay 200 can be reused. The separation-type storage bay 200 may be re-attached to the storage control device 100 that was first mounted or may be attached to a storage control device 100 other than the storage control device 100 that was first mounted. Alternatively, the separation-type storage bay 200 from which data have been erased can also be stored as a spare without being attached to the storage control device 100. Because the management information is erased altogether as well as the backup data, the separation-type storage bay 200 can be mounted in any storage control device 100. Further, because the backup data is erased, the probability of data being fraudulently extracted can be reduced. The configuration may also be such that the stored content of the separation-type storage bay 200 is automatically erased at the same time as the completion of the data copying from the separation-type storage bay 200 to the backup device 30.

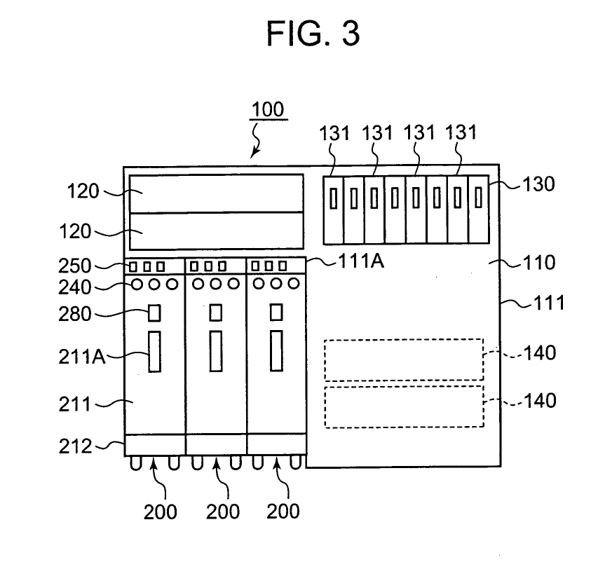

FIG. 3 is a schematic diagram in which the storage control device 100 is viewed from the front side. The appearance and mechanical configuration of the storage control device 100 and separation-type storage bay 200 are not limited to those illustrated in FIG. 3, it being possible to adopt a variety of appearances and mechanical configurations.

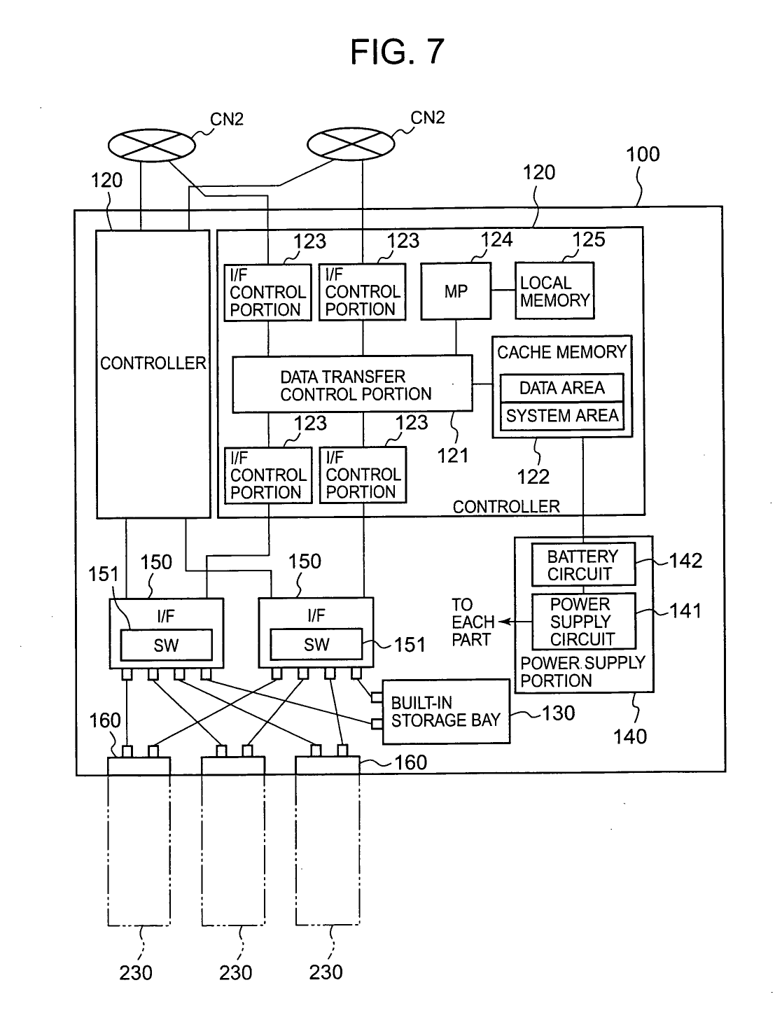

The storage control device 100 is broadly classified as a device main body 110 and one or a plurality of separation-type storage bays 200 that are detachably mounted in the device main body 110. The device main body 110 can be configured comprising an enclosure 111, a plurality of controllers 120 that are mounted in the enclosure 111, a built-in storage bay 130 that is attached to the enclosure 111, a plurality of power portions 140 attached to the enclosure 111, and a plurality of interfaces 150 and connectors 160 connected to the enclosure 111 (all described subsequently in conjunction with FIG. 7) and so forth, for example.

Because the details of each part will be described subsequently, these parts are each described simply here. Each controller 120 controls the exchange of data between the built-in storage bay 130 and separation-type storage bay 200. Further, each controller 120 processes access requests from the server 10 and reads and writes data to and from the built-in storage bay 130 and separation-type storage bay 200.

The built-in storage bay 130 is provided in the device main body 110 and comprises a plurality of disk drives 131. Each disk drive 131 can be individually removed from the device main body 110. However, the built-in storage bay 130 differs from the separation-type storage bay 200 and does not comprise an arrangement for removal while retaining the conformance of the stored content stored in each disk drive 131.

Each power supply portion 140 supplies predetermined power to each controller 120, the built-in storage bay 130, and each separation-type storage bay 200. The provision of the plurality of power supply portions 140 makes the configuration of the power supply system redundant and serves to increase reliability. Likewise, a plurality of controllers 120 are also provided in order to increase reliability by rendering the communication processing system and data processing system redundant.

The details will be provided subsequently but each separation-type storage bay 200 can be configured comprising an enclosure 211, a handle 211A that is attached to the enclosure 211, a wheel portion 212, an indicator portion 240, an operating switch portion 250, and an SVP interface 280 and so forth.

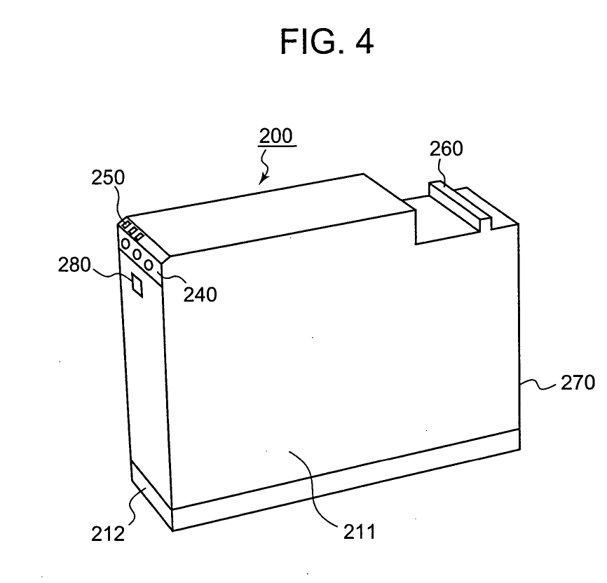

FIG. 4 is a perspective view that schematically shows the separation-type storage bay 200 in which the handle 211A is omitted. The wheel portion 212 is provided on the underside of the separation-type storage bay 200. The separation-type storage bay 200 can be transported simply by the wheel portion 212.

The indicator portion 240 and operating switch portion 250 are each provided at the top of the front face of the separation-type storage bay 200. The indicator portion 240 can be configured by a thin-type display panel and an LED lamp and so forth, for example. The indicator portion 240 is able to display a plurality of states such as whether the power supply is ON, where access is taking place, and whether an error has occurred, for example. The operating switch 250 can be configured by one or a plurality of pushbutton switches or the like, for example. Examples of types of operating switches include a power supply switch and data erasure switch and so forth, for example. Further, a man-machine interface for receiving speech instructions or other instructions, for example, may be provided in place of a manual operation switch or in addition to a manual device switch.

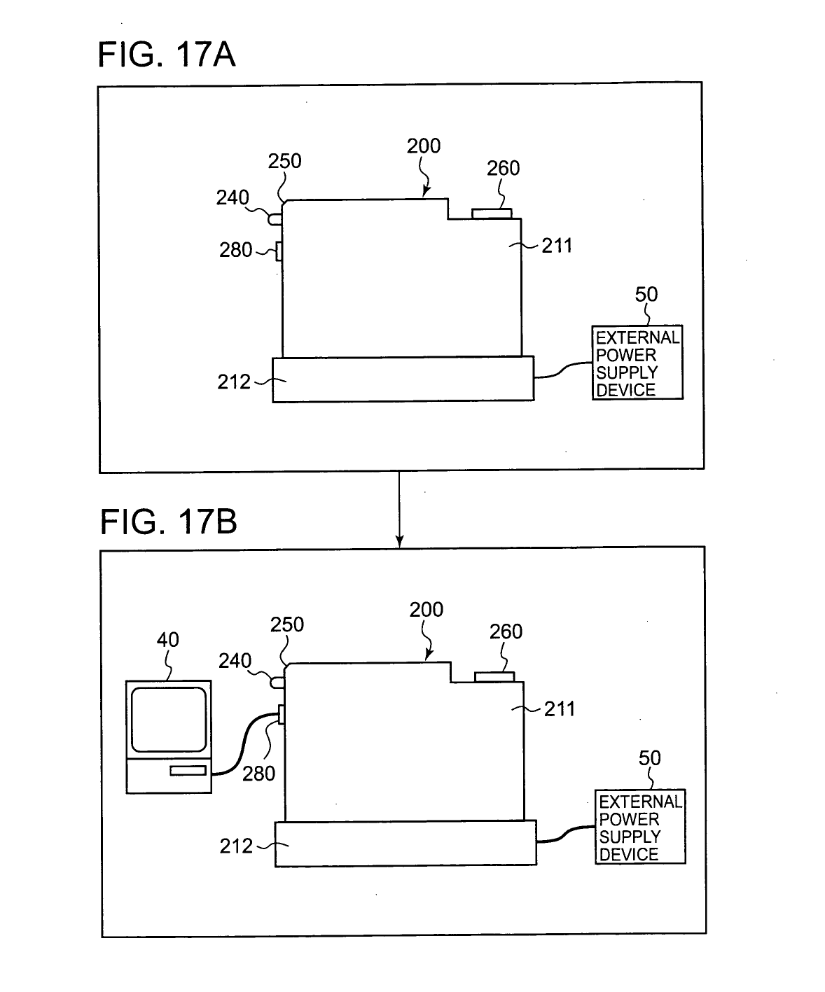

An interface 280 for a connection to the management terminal (SVP) 40 is provided on the front face of the separation-type storage bay 200. Further, a connector 260 for connecting to the device main body 110 is provided on the upper face of the separation-type storage bay 200. A power supply connector 270 for obtaining power from an external power supply (See FIG. 17) 50 is also provided at the bottom of the rear side of the separation-type storage bay 200. Further, an external power supply 50 is not necessarily required and a configuration in which a battery power supply, a fuel cell and so forth, for example, are provided in the separation-type storage bay 200 is possible. When a fuel cell is adopted, an opening for the introduction of fuel and an opening for the exchange of fuel receptacles can be provided in the enclosure 211.

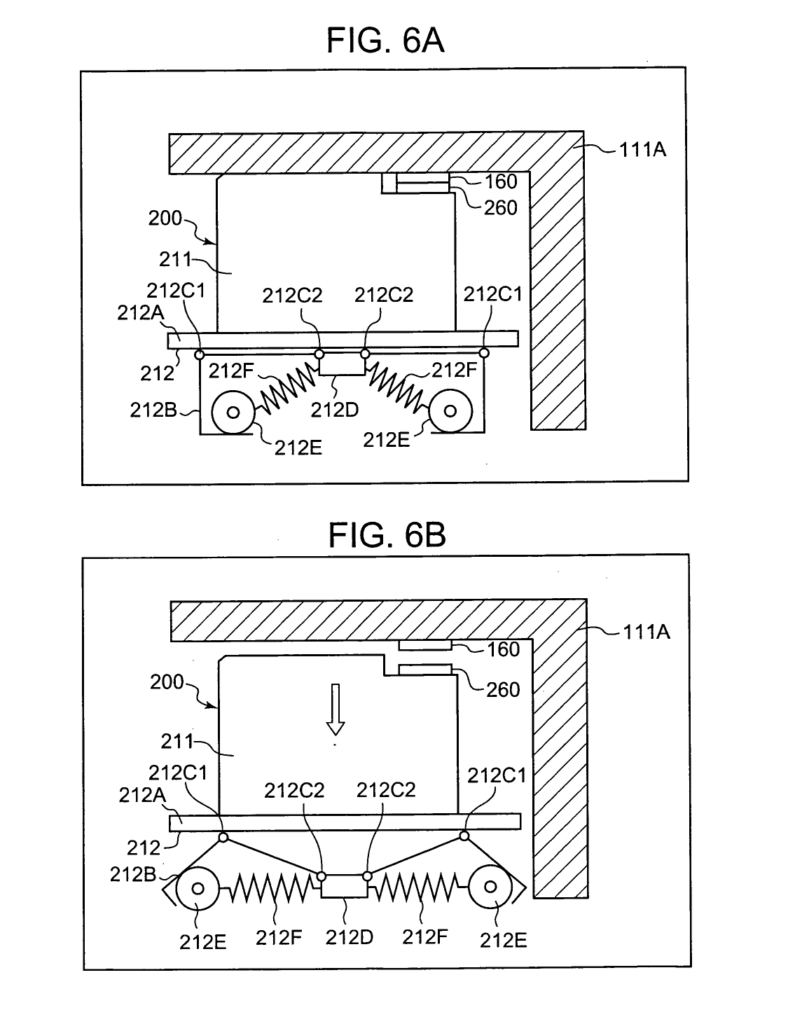

FIG. 6 is an explanatory view of the configuration and so forth of the wheel portion 212. FIG. 6A shows a state where the separation-type storage bay 200 is attached to the device main body 110. The wheel portion 212 can be configured comprising a base 212A, a movable casing 212B, a support portion 212D, and a plurality of wheels 212E, for example.

For example, the base 212A formed in a planar shape is attached to the underside of the enclosure 211 and the movable casing 212B is attached via a hinge 212C1 to the underside of the base 212A. The movable casing 212B is partitioned by a plurality of members and each partition member is turnably attached to the support portion 212D by another hinge 212C2.

The support portion 212D is attached via the hinge 212C2 to the center portion of the movable casing 212B. The support portion 212D serves to support each wheel 212E. Each wheel 212E is suspended by respective coil springs 212F. Each spring 212F usually moves in a direction to push the enclosure 211 upward.

As shown in FIG. 6A, a connector 160 is provided on the face 111A in the enclosure 111 at the point where the separation-type storage bay 200 is attached. The connector 160 and the connector 260 of the separation-type storage bay 200 are mechanically connected. The connectors 160 and 260 are connected by a suitable pressure by means of the spring force of each spring 212F.

FIG. 6B is an explanatory view of an aspect in which the separation-type storage bay 200 is removed from the device main body 110. The user pushes the enclosure 211 downward against the spring force of each spring 212F. As a result, the movable casing 212B is pushed and the connector 260 is usually separated from the connector 160. The user pulls the separation-type storage bay 200 forward from the front face of the device main body 110 in a state where the enclosure 211 is still pushed downward. When the separation-type storage bay 200 is pulled from the device main body 110 and the user lets go, the enclosure 211 moves upward under the spring force of each spring 212F. Further, the user is able to transport the separation-type storage bay 200 by grasping the handle 211A. Each wheel 212E, which is provided in the separation-type storage bay 200, aids the transportation operation by the user.

FIG. 7 is a block diagram showing the configuration of the device main body 110 of the storage control device 100. The device main body 110 is provided with the respective controllers 120, a built-in storage bay 130, a power supply portion 140, a storage bay connection interface 150, and a connector 160.

Each controller 120 controls the operation of the storage control device 100. Each controller 120 can be configured comprising a data transfer control portion 121, a cache memory 122, a plurality of interface control portions 123, a microprocessor (MP) 124, and a local memory 125, for example.

The data transfer control portion 121 controls data transfers between the server 10 and the respective storage bays 130 and 200. The cache memory 122 is provided with a system area and a data area and stores user data and so forth. Each interface control portion 123 performs data exchanges between the server 10 or the respective storage bays 130 and 200. A first interface control portion 123 is connected to the server 10 via a communication network CN2 and performs data communications with server 10 according to a predetermined protocol. Examples of a predetermined protocol can include SAN or TCP/IP (Transmission Control Protocol/Internet Protocol), for example. The second interface control portion 123 performs data communications with the respective storage bays 130 and 200 via a storage bay connection interface portion 150. The microprocessor 124 controls the overall operation of the controller 120. The local memory 125 is configured by a nonvolatile memory and stores a table and genealogy information and so forth that will be described subsequently.

The built-in storage bay 130 is configured to connect a plurality of disk drives 131 in the form of an array. The power supply portion 140 supplies predetermined power to each of the power-consuming parts of the storage control device 100. The power supply portion 140 can comprise a power supply circuit 141 and a battery circuit 142, for example. The power that is input from an external commercial power source or electricity line is adjusted by the power supply circuit 141 and is supplied to each part. The battery circuit 142 operates when the power supply from the power supply circuit 141 has stopped and the operation of the storage control device 100 is maintained for the time required for normal completion.

Each interface portion 150 is connected to each of the storage bays 130 and 200 and performs data communications with the respective storage bays 130 and 200. Each interface portion 150 comprises a switch portion 151 and is connected to the respective storage bays 130 and 200. As a result, the path to the respective storage bays 130 and 200 is made redundant and, even when either one of the interface portions 150 is inoperable, the storage bays 130 and 200 can be accessed via the second interface portion 150.

The connector 160 is provided in each bay slot 230 and connected to the connector 260 of the separation-type storage bay 200. The bay slot 230 is a slot for attaching the separation-type storage bay 200.

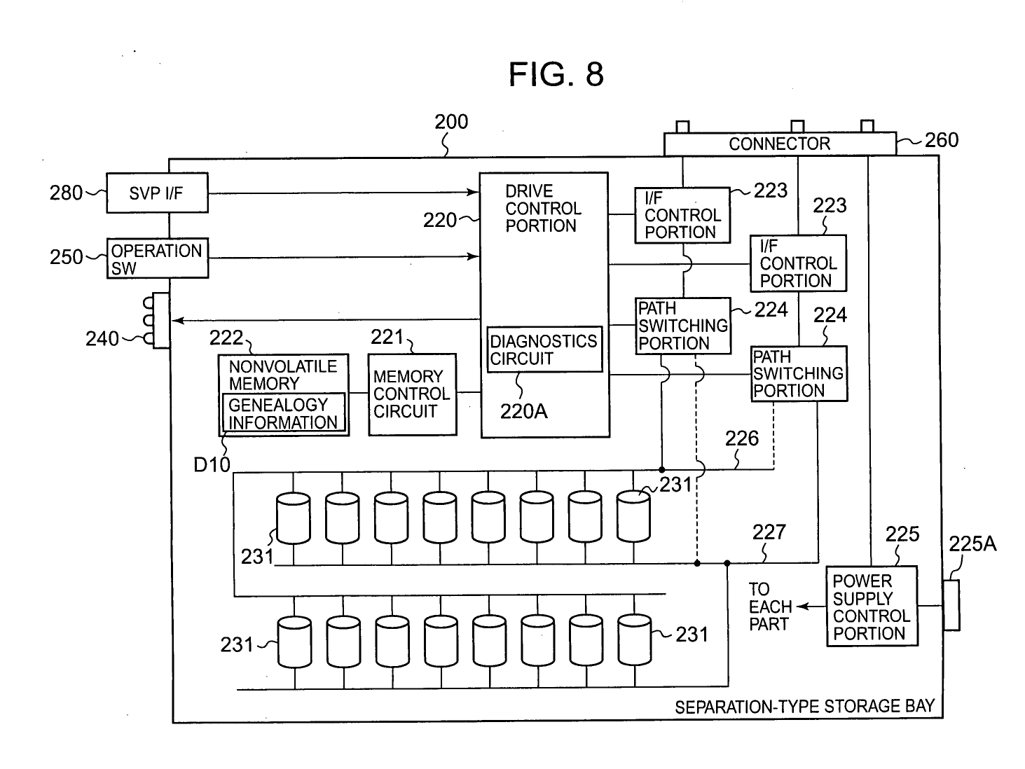

FIG. 8 is a block diagram showing the configuration of the separation-type storage bay 200. The separation-type storage bay 200 can be configured comprising an enclosure 211, wheel portion 212, drive control portion 220, memory control circuit 221, nonvolatile memory 222, a plurality of interface control portions 223, a plurality of path switching portions 224, a power supply control portion 225, a plurality of disk drives 231, an indicator portion 240, an operating switch portion 250, and an SVP interface 280, for example.

The drive control portion 220 performs data exchange with each of the disk drives 231 and constitutes a controller for a memory control circuit 221, nonvolatile memory 222, interface control portion 223, path switching portion 224, and the separation-type storage bay 200, for example. The drive control portion 220 comprises a diagnostic circuit 220A for performing self-diagnostics with regard to whether access to the disk drive 231 may be normally performed and so forth. The memory control circuit 221 is a circuit for inputting and outputting data to and from the nonvolatile memory 222. Genealogy information D10 is stored in the nonvolatile memory 222. An indicator portion 240, operating switch 250 and SVP interface 280 are each connected to the drive control portion 220. The drive control portion 220 is able to perform a predetermined operation in accordance with instructions from the operating switch portion 250 or management terminal 40. Further, the drive control portion 220 is able to communicate the status of the separation-type storage bay 200 to the outside via the interface portion 240.

Each interface control portion 223 is connected to the interface control portion 123 of the device main body 110 via the connectors 260 and 130 and performs data communications in accordance with a predetermined protocol. Each path switching portion 224 is a circuit for switching the access path to the disk drive 231. Each disk drive 231 is able to participate in each of a plurality of loops 226 and 227 and is able to access the desired disk drive 131 via any one loop. For example, the first path switching portion 224 accesses each disk drive 231 via a first loop 226 while the second path switching portion 224 accesses each disk drive 231 via the other loop 227. Each path switching portion 224 is able to select either one of the respective loops 226 and 227. When there is a fault in the loop 226 that is normally used, the first path switching portion 224 switches to the other loop 227. Likewise, the other path switching portion 224 switches to the first loop 226 when a fault occurs in the other loop 227.

The power supply control portion 225 supplies power supplied via the connector 260 from the device main body 110 to each part within the separation-type storage bay 200. The power supply control portion 225 is also able to supply power to each part by adjusting the power from the external power supply 50.

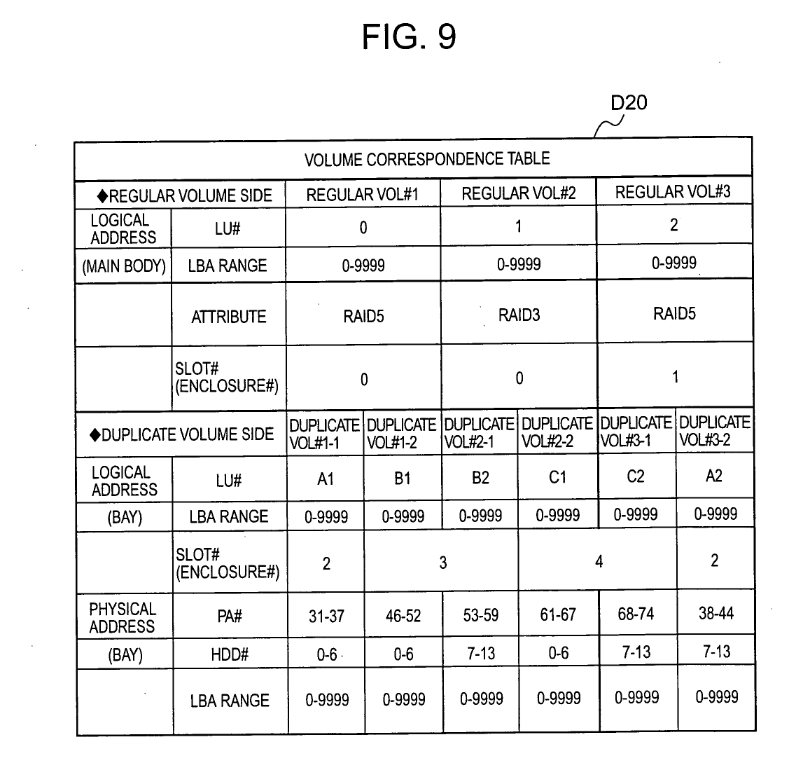

FIG. 9 is an explanatory view of the configuration of a volume correspondence table D20. The volume correspondence table D20 serves to manage the relationship of correspondence between each of the logical volumes in the storage control device 100 and the disk drives 131 and 231 and is stored in the system area of the cache memory 122, for example. Further, the table D20 represents a case where the storage control device 100 comprises a plurality of built-in storage bays 130 and a plurality of separation-type storage bays 200. Further, the specific numerical values in the table and genealogy information and so forth are values used for expediency in the description, and, excluding specific cases in particular, there is no deliberate attempt at consistency within tables or between tables.

Information relating to a regular volume and information relating to a duplicate volume are associated with the volume correspondence table D20. Information relating to a regular volume can include the ID (identification information) of each regular volume, LUN (Logical Unit Number), range of the LBA (Logical Block Address), attribute (RAID level), and storage bay slot number, for example. The LUN (LU#) is the identification number set for a logical volume. The LBA range indicates the range of logical addresses of the regular volumes and the volume size can be detected on the basis of the LBA range. An attribute is information indicating the level of the RAID configuration. RAID0, RAID1, and RAID5 and so forth, for example, are known as RAID levels. The slot number is information for specifying the disk array in which the regular volume is established. That is, numbers for uniquely specifying the built-in storage bays 130 and separation-type storage bays 200 within the storage control device 100 are established.

Examples of information relating to a duplicate volume can include the volume ID for identifying each duplicate volume, the LUN (LU#), LBA range, storage bay slot number, physical address (PA#), drive number (HDD#), and information indicating the range of the physical addresses (LBA range), for example. A physical address is information for uniquely specifying each disk drive 231 in the storage control device 100 and is established by the controller 120. Further, the drive number is information for specifying the disk drive 231 that corresponds with the physical address.

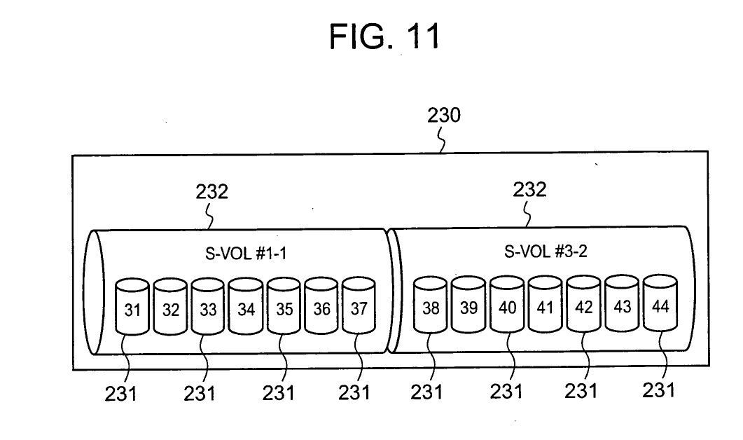

FIG. 11 will be referenced first. FIG. 11 is an explanatory view that schematically shows the relationship between a physical address and a volume. A physical address is information specifying the physical drive constituting each duplicate volume 232. However, the physical address is set by the controller 120 and is information on the system management used, and the physical address differs from the drive number.

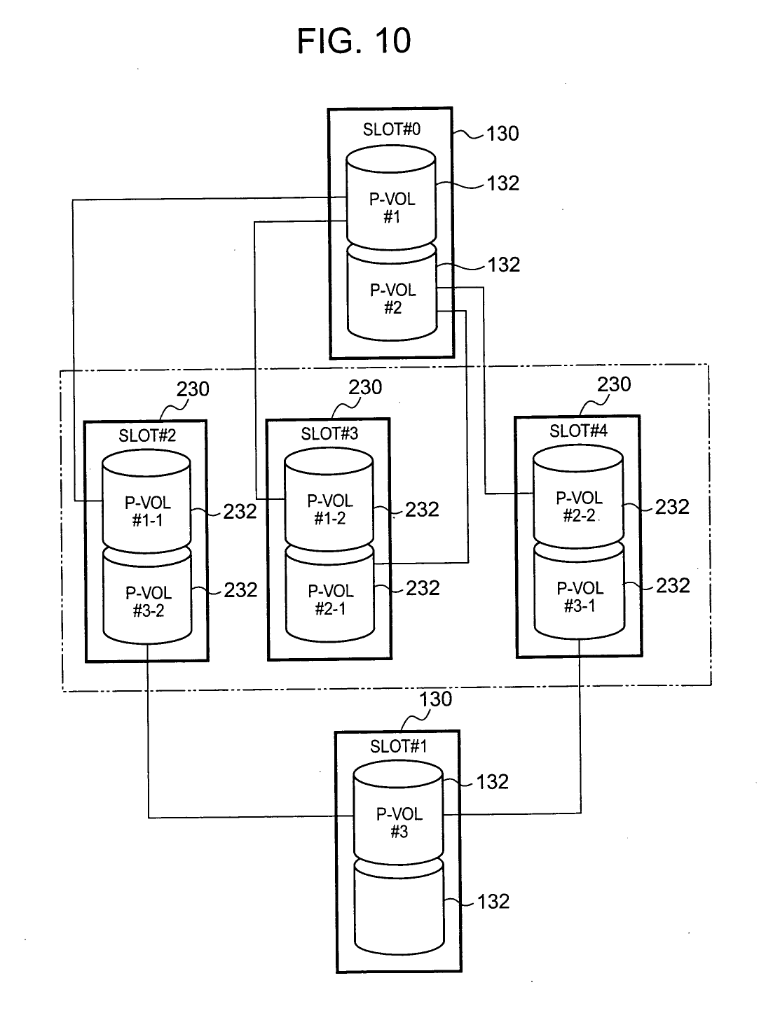

FIG. 10 is an explanatory view of the relationship between a regular volume 132, a duplicate volume 232 and each bay slot (disk array) 230. SLOT#0 and #1 each correspond with a built-in storage bay 130. The regular volumes P-VOL#1 and P-VOL#2 are established in SLOT#0 and regular volumes P-VOL#3 is established in SLOT#1. SLOT#2 to #4 each correspond with a separation-type storage bay 200. Duplicate volumes S-VOL#1-1 and S-VOL#3-2 are prepared for SLOT#2, duplicate volumes S-VOL#1-2 and S-VOL#2-1 are prepared for SLOT#3, and duplicate volumes S-VOL#2-2 and S-VOL#3-1 are prepared for SLOT#4.

Here, the S-VOL#1-1 and S-VOL#1-2 correspond with the P-VOL#1, the S-VOL#2-1 and S-VOL#2-2 correspond with the P-VOL#2, and the S-VOL#3-1 and S-VOL#3-2 correspond with the P-VOL#3. Further, it is shown that the S-VOL#1-1 is a first-generation backup of the P-VOL#1 and the S-VOL#1-2 is a second-generation backup of the P-VOL#1. Similarly also to the other S-VOL, the leading number is information indicating the corresponding regular volume and the next number is information showing the generation of the backup.

Here, it should be noted that a plurality of backup data created for one regular volume 132 is stored in different separation-type storage bays 200. Two sets of backup data for the regular volume P-VOL#1 are stored in SLOT#2 and SLOT#3 and, also like the other regular volumes P-VOL#2 and P-VOL#3, the backup data for each generation are stored in physically different SLOTs. Therefore, even when a fault occurs in one separation-type storage bay 200, backup data that is stored in the other separation-type storage bay 200 can be used.

Further, it should be noted that the duplicate volume 232 corresponding with each of the different regular volumes 132 can be mixed in the respective separation-type storage bays 200. The separation-type storage bay 200 is a simple portable disk array device that contains a plurality of disk drives 231, differs from a general storage drive, and allows volumes 232 of a plurality of types to be mixed.

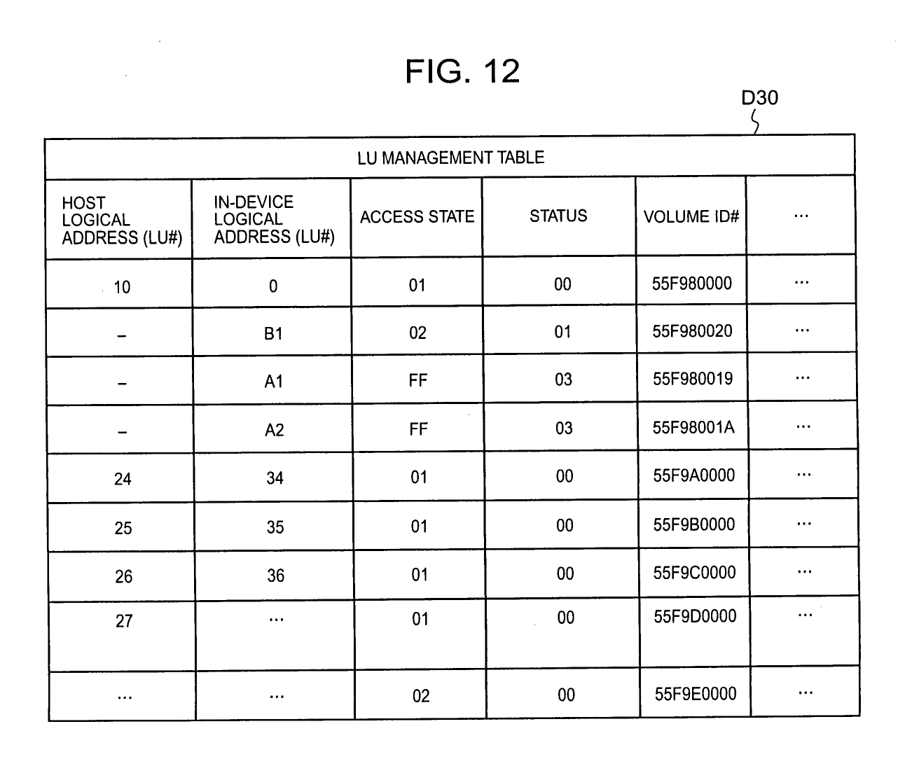

FIG. 12 is an explanatory view of the configuration of the logical volume (LU) management table D30. The LU management table D30 manages the states of each volume in the storage control device 100 and is stored in the system area of the cache memory 122, for example.

The LU management table D30 can be configured by matching the host logical address (LU#), in-device logical address (LU#), address state, volume status, and volume ID, for example.

The host logical address is information indicating the LUN of the logical volume recognized by the server 10. The server 10 accesses the regular volume 132 but does not directly access the duplicate volume 232 and, therefore, the host logical address is established only for the regular volume 132.

The in-device logical address is a LUN for managing each logical volume in the storage control device 100. The in-device logical address is established by the controller 120 of the storage control device 100.

The access state is access control information indicating whether the respective logical volumes 132 and 232 can be accessed. Examples of access states include ‘read/writable (01)’, ‘read only (02)’, ‘access prohibited (03)’, and ‘inaccessible (FF)’, and so forth.

The read/writable status (01) signifies that both the data writing to the volume and data reading are both possible. The read only status (02) means that only data reading from the volume is allowed and that data writing is prohibited. The access prohibited status (03) means that the volume is locked and access itself is prohibited. The inaccessible status (FF) means that the volume is locked and access is impossible. The inaccessible status is established when an anomaly occurs in the volume, for example. Here, either the read only status or access prohibited status can be established for the respective duplicate volumes 232 in the separation-type storage bay 200. As a result, falsification of the backup data by a third party or reading of the backup data by a third party can be suppressed.

The volume status is information indicating the attribute of the volume and includes information indicating whether the volume is either a regular volume or duplicate volume or indicating the particular status of the volume. Examples of the volume status can include the ‘regular volume (00)’, ‘duplicate volume (pair state) (01)’, ‘duplicate volume (split-connection state)’, ‘duplicate volume (split-separation state) (03)’, and ‘duplicate volume (backup in progress state) (04)’, and so forth, for example.

The ‘regular volume status (00) means that the logical volume is a regular volume. The pair state (01), split-connection state (02), split-separation state (03), and backup in progress state (04) are statuses that are set only for the respective duplicate volumes 232.

The pair state (01) means that the duplicate volume and regular volume generate a copy pair. The split-connection state (02) signifies a state where the duplicate volume is logically separated from regular volume but physically connected thereto. The split-separation state (03) signifies a state where the duplicate volume is logically and physically separated from the regular volume. The backup in progress state (04) signifies that the data of the regular volume is being copied to the duplicate volume.

The volume ID is identification information for specifying the respective volumes. The volume ID can be configured by two parts. The first is a unique ID that is obtained through computation from the device number and LUN that are preset for the storage control device 100. The other one is a numerical value following the unique ID. For example, in the case of the regular volume, the numeral is fixed as ‘0000’. In the case of a duplicate volume, the numeral is an additional number. An additional number is a serial number that is established through a serial increase one by one.

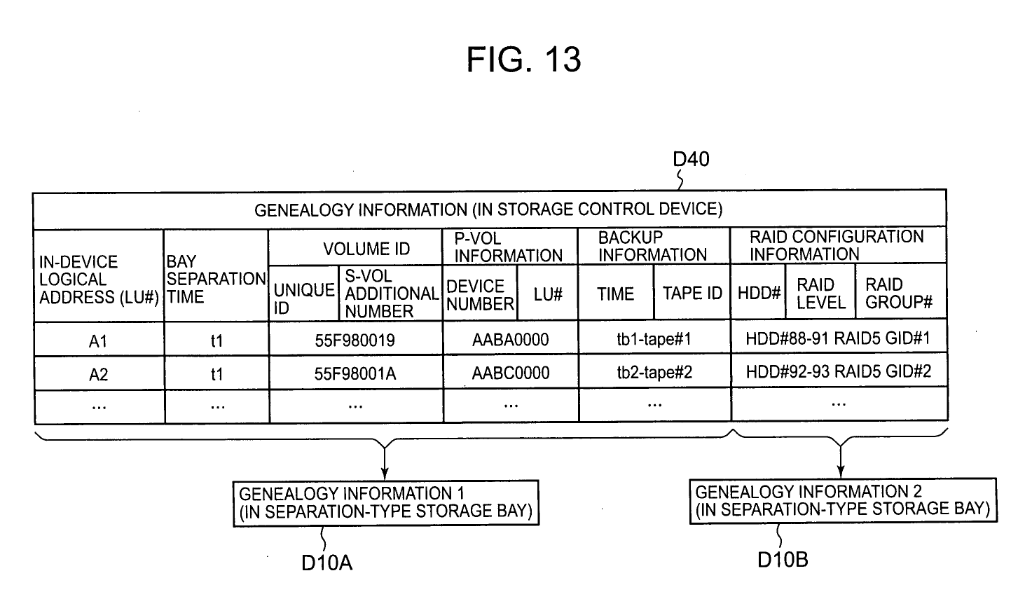

FIG. 13 is an explanatory view of the configuration of genealogy information D40 that is held in the controller 120 of the storage control device 100. The genealogy information D40 is management information that is used in order that the controller 120 employ each of the separation-type storage bays 200.

The genealogy information D40 can be configured, for example, by associating an in-device logical address (LU#), bay separation time, volume ID, regular volume information (P-VOL information), backup information, and RAID configuration information.

As mentioned earlier, the in-device logical address is a value that is set for each logical volume in the storage control device 100. The bay separation time is information indicating the time at which the separation-type storage bay 200 is separated from the device main body 110. As mentioned earlier, the volume ID is information for uniquely specifying each of the logical volumes in the storage control device 100 and is configured by a unique ID and additional number. The regular volume information is information for identifying each regular volume corresponding with a duplicate volume in the separation-type storage bay 200 and is configured by a device number and LU number. The backup information is information for managing a state of copying to the backup device 30 and is configured comprising information (tape ID) specifying a backed up time and a backup destination. RAID configuration information is information indicating the RAID configuration of the logical volume (duplicate volume) and can be configured comprising a drive number, RAID level, and RAID group number, for example. The RAID group number is a number for specifying each RAID group. The RAID group indicates the RAID level of the RAID group. The drive number is information specifying the disk drive 231 constituting the RAID group. Further, a spare flag for distinguishing whether each disk drive 231 is a regular drive (drive currently being used) or a spare drive can also be provided in the RAID configuration information.

The controller 120 is able to grasp the physical configuration and logical configuration of each separation-type storage bay 200 by means of the genealogy information D40. The genealogy information D40 stores first genealogy information D10A and second genealogy information D10B in a nonvolatile memory 222 of each separation-type storage bay 200.

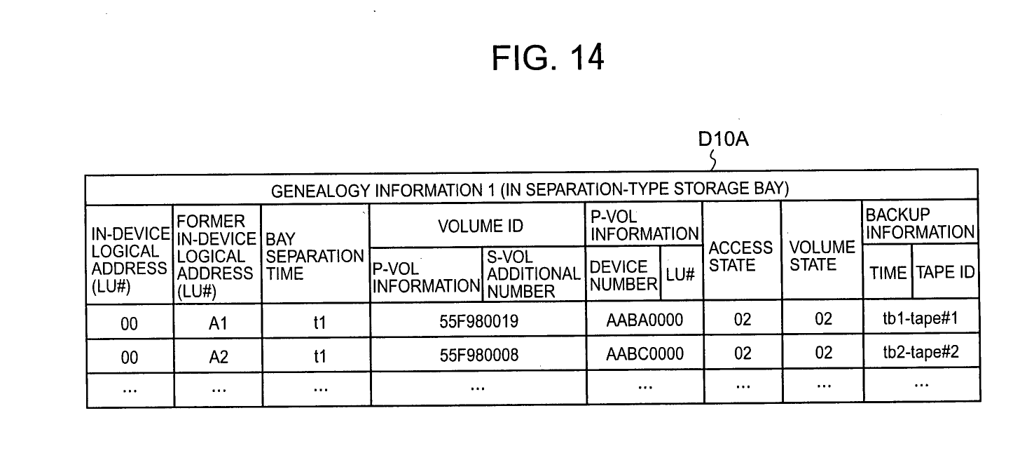

FIG. 14 is an explanatory view of the configuration of the first genealogy information D10A that is stored in the separation-type storage bay 200. The first genealogy information D10A constitutes storage bay genealogy information D10 as well as the second genealogy information D10B described subsequently.

The first genealogy information D10A is configured by a portion of the genealogy information D40 in the storage control device 100 and the stored content of the LU management table D30. The first genealogy information D10A can be configured by associating an in-device logical address, a former in-device logical address, a bay separation time, a volume ID, regular volume information, an access state, a volume status, and backup information. The former in-device logical address signifies the in-device logical address immediately before separating the separation-type storage bay 200 from the device main body 110. The in-device logical address is a value that can change each time the separation-type storage bay 200 is attached to the device main body 110.

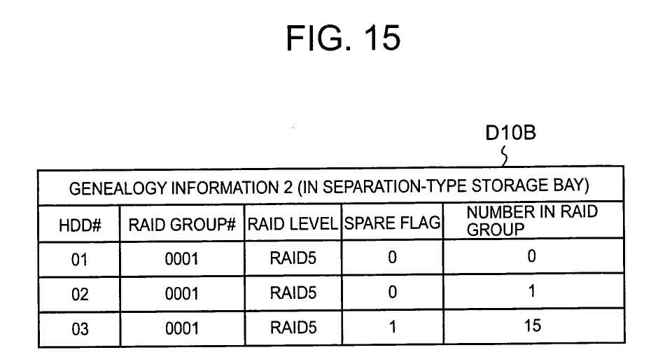

FIG. 15 is an explanatory view of the configuration of the second genealogy information D10B. The second genealogy information D10B is generated on the basis of the RAID configuration information in the genealogy information D40. The second genealogy information D10B can be configured by associating the drive number, RAID group number, RAID level, spare flag, and drive number in the RAID group. The drive number in the RAID group is the drive number that is established in the RAID group.

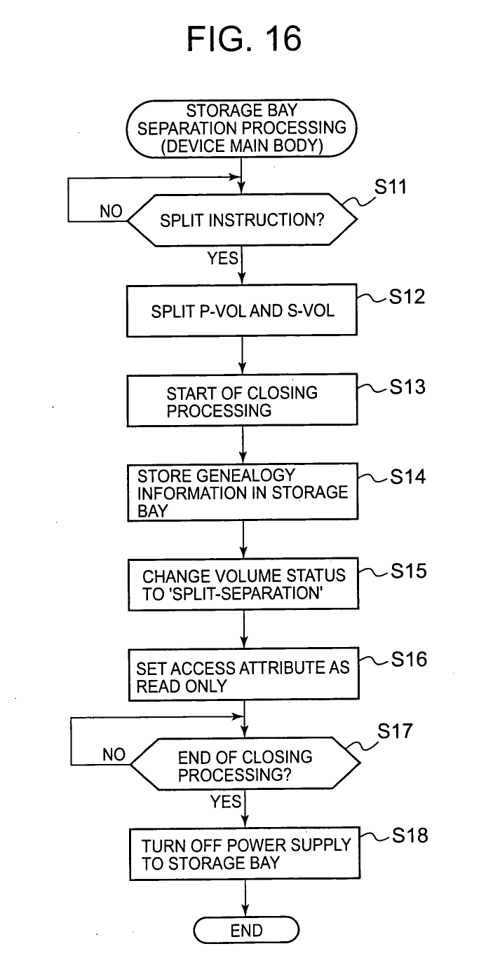

The operation of this embodiment will be described next. FIG. 16 is a flowchart showing the processing when the separation-type storage bay 200 is removed from the device main body 110. The processing is executed by the controller 120 of the storage control device 100. Further, although the respective processing (described subsequently) is also similar but the outline of the operation is shown in the flowchart, the actual program is different.

The controller 120 judges whether an instruction for a volume split has been issued by the user (S11). The user is able to issue various instructions from the server 10 to the controller 120, for example. Alternatively, by connecting the management terminal 40 to the storage control device 100, the user is able to supply various instructions to the storage control device 100 via the management terminal 40.

When a split instruction has been input (S11:YES), the controller 120 cancels the paired state of the regular volume and duplicate volume to split the two volumes (S12) and closing processing is started (S13). In the closing processing, processing such as writing data that is stored in the cache memory 122 to the duplicate volume, for example, is performed.

The controller 120 stores genealogy information D10 in the nonvolatile memory 222 of the separation-type storage bay 200 (S14) That is, first genealogy information D10A and second genealogy information D10B are each created on the basis of the genealogy information D40 and LU management table D30 and then stored in the nonvolatile memory 222 of the separation-type storage bay 200. Thus, while the separation-type storage bay 200 is attached to the device main body 110, there is not need to store the genealogy information D10 in the separation-type storage bay 200, nor is there any need to update this genealogy information D10. While the separation-type storage bay 200 is attached to the device main body 110, the separation-type storage bay 200 is used on the basis of the genealogy information D40 in the controller 120.

The controller 120 changes the status of the duplicate volume to ‘split-separation’ and updates the genealogy information D10 (S15). Further, the controller 120 establishes ‘read only’ for the logical volume in the separation-type storage bay 200 (S16). After confirming that the closing processing has ended (S17:YES), the controller 120 then ends this processing by stopping the supply of power to the separation-type storage bay 200 (S18). The user is able to confirm that the separation-type storage bay 200 has entered a removable state via the display of the indicator portion 240 and the terminal screen of the management terminal 40, for example. The user cancels the connection of the connectors 160 and 260 by pushing the separation-type storage bay 200 downward and pulls the separation-type storage bay 200 from the device main body 110. The user is able to transport the separation-type storage bay 200 that has been removed from the device main body 110 to the backup site or is able to store the separation-type storage bay 200 in a warehouse or safe or the like.

The self-diagnostic function of the separation-type storage bay 200 will be described next. FIG. 17 is a perspective view of an aspect in which a self-diagnostic function is carried out by supplying power by attaching the external power supply 50 to the separation-type storage bay 200 that has been removed from the device main body 110. FIG. 17A represents a case where only the external power supply 50 is connected to the separation-type storage bay 200 and self-diagnostics are executed by means of an instruction from the operating switch portion 250. FIG. 17B represents a case where the external power supply 50 and management terminal 40 are connected to the separation-type storage bay 200 and self diagnostics are executed by means of an instruction from the management terminal 40.

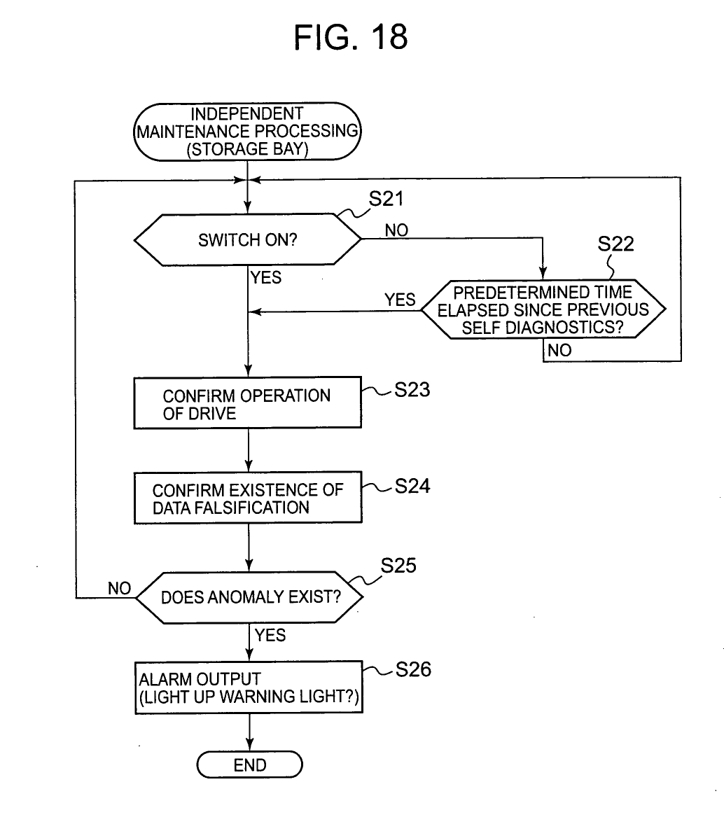

FIG. 18 is a flowchart showing maintenance processing (self-diagnostic processing) that is executed by only the separation-type storage bay 200. This processing is started when the operating switch portion 250 is operated, for example (S21:YES). A power supply switch, for example, can be used as a switch for indicating the start of self diagnostics.

Further, when the external power supply 50 is connected to the separation-type storage bay 200 and power is already being supplied, it is monitored whether a predetermined time has elapsed since the previous self diagnostics time (S22). Each time the predetermined time has elapsed (S22:YES), the self-diagnostics may be executed automatically. Therefore, it is possible to use either or both of first a case where a predetermined switch operation is effected and second a case where a predetermined time has elapsed as the trigger for self-diagnostics processing that is performed independently by the separation-type storage bay 200.

When self-diagnostics are started, the diagnostics circuit 220A of the drive control portion 220 confirms whether each disk drive 231 operates normally (S23) and then judges whether the data that is stored in each disk drive 231 has been falsified (S24). It is then judged whether a drive anomaly or data falsification (hereinafter ‘anomaly or the like’) has been detected (S25) and, when an anomaly or the like has been detected (S25:YES), the drive control portion 220 communicates the occurrence of an anomaly via the indicator portion 240 (S26). An example of a method of detecting data falsification will be described subsequently.

As methods for communicating an anomaly, methods according to which the lamp of the indicator portion 240 is made to light up, a warning message is displayed on the display, or a warning buzzer is sounded may be considered. Alternatively, the configuration may be such that the separation-type storage bay 200 is provided with a wireless communication function and an alarm signal or alarm message is transmitted to the outside.

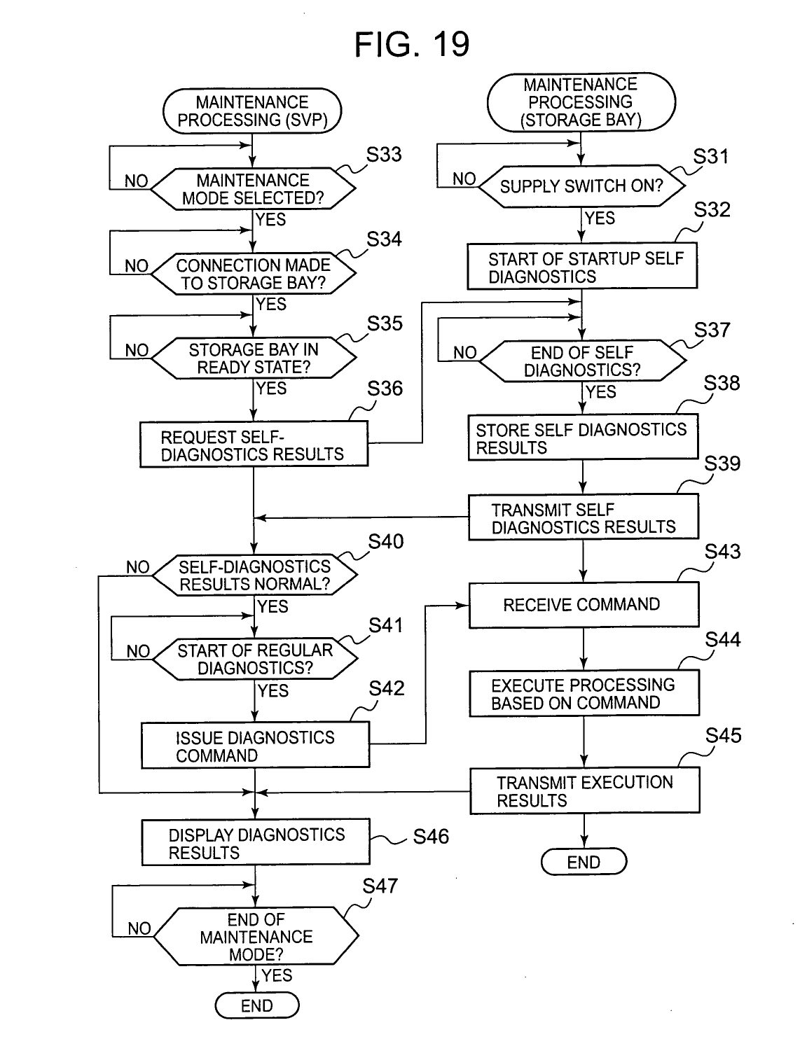

FIG. 19 is a flowchart showing maintenance processing (self-diagnostics processing) that is executed in cooperation with the management terminal 40. At first, the user turns ON the power supply switch of the separation-type storage bay 200 after connecting the external power supply 50 and management terminal 40 to the separation-type storage bay 200 (S31:YES). As a result, the diagnostics circuit 220A of the separation-type storage bay 200 executes self-diagnostics processing that is described in conjunction with FIG. 18 (S32). The self-diagnostics processing can be called start-up self-diagnostics processing.

Meanwhile, the user selects a maintenance mode via the user interface of the management terminal 40 (S33). When a maintenance mode is selected (S33:YES), the management terminal 40 confirms whether a connection has been made with the separation-type storage bay 200 (S34) and whether the separation-type storage bay 200 is in the ready state (S35). After confirming that there is a connection with the separation-type storage bay 200 in a ready state (S34:YES, S35:YES), the management terminal 40 requests the results of startup self-diagnostics processing from the separation-type storage bay 200 (S36).

Upon completion of startup self-diagnostics processing (S37:YES), the separation-type storage bay 200 stores the diagnostics result (S38). The separation-type storage bay 200 then transmits the results of the startup self-diagnostics processing to the management terminal 40 in accordance with the request from the management terminal 40 (S39).

Upon receipt of the self diagnostics results from the separation-type storage bay 200, the management terminal 40 judges whether the diagnostics results are normal (S40). When the results of the startup self-diagnostics are normal, that is, when an anomaly or the like has not been detected (S40:YES), the management terminal 40 judges whether the start of regular diagnostics has been instructed by the user (S41). Regular diagnostics signifies more detailed diagnostics processing than startup self-diagnostics processing. When the user desires regular diagnostics (S41:YES), the management terminal 40 issues one or a plurality of diagnostics commands to the separation-type storage bay 200 (S42). Diagnostics commands can include commands for measuring the transfer speed when data is read from each disk drive 231, for example. Data falsification detection processing may be performed during regular diagnostics rather than being included in startup diagnostics processing.

Upon receipt of a diagnostics command (S43), the separation-type storage bay 200 performs processing on the basis of the command (S44) and transmits the results to the management terminal 40 (S45). As a result, the management terminal 40 displays the results of the startup diagnostics processing and the regular diagnostics processing on the terminal screen (S46). An example of the screen will be described subsequently. When an anomaly or the like exists in the startup diagnostics processing (S40:NO), the management terminal 40 displays the results of the startup diagnostics processing on the terminal screen without performing regular diagnostics. Further, this processing ends when the user selects the end of the maintenance mode (S47:YES). Further, the configuration may be such that, when the user desires to execute regular diagnostics (S41:NO), S42 is skipped and the processing moves to S46.

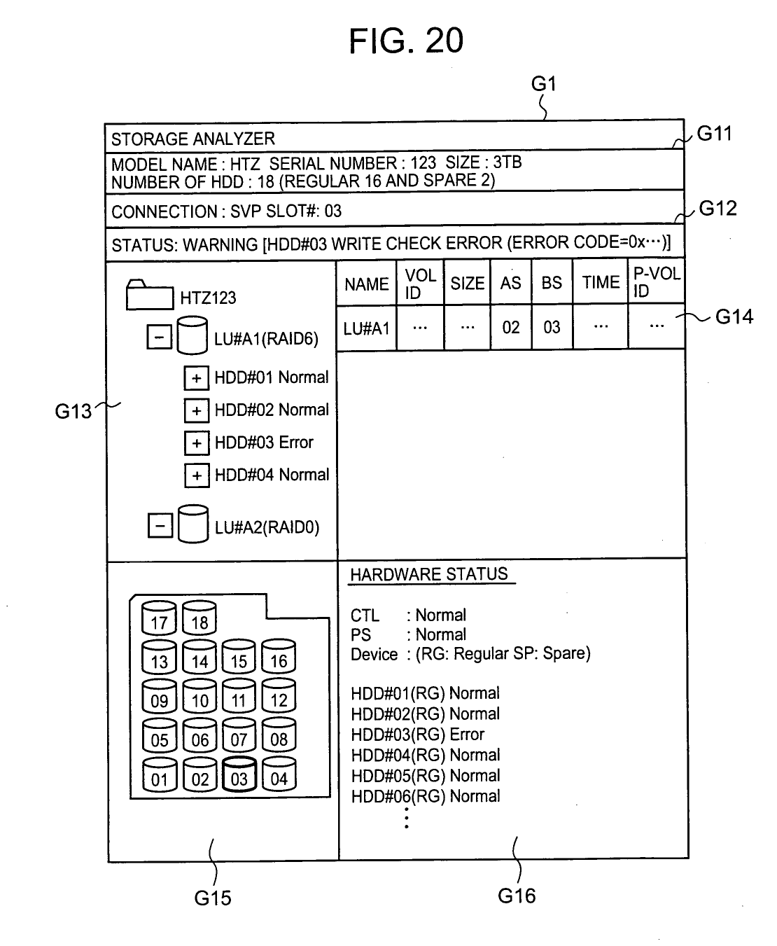

FIG. 20 is an explanatory view of a diagnostics screen that is displayed on the screen of the management terminal 40. This diagnostics screen can comprise, for example, a display portion G11 for specifying the device that is to undergo diagnostics, a display portion G12 for displaying the diagnostics evaluation, a display portion G13 for displaying the configuration of the separation-type storage bay 200 in a tree format, a display portion G14 for showing the details of the configuration of the separation-type storage bay 200, a display portion G15 for showing the drive position of the separation-type storage bay 200 in schematic form, and a display portion G16 for showing the state of each disk drive 231.

Display portion G11 displays the model name and serial number of the separation-type storage bay 200, the size of the storage capacity, and the number of mounted disk drives 231 and so forth, for example. The display portion G12 displays an indication, error code, and so forth for a problem that is detected in the self diagnostics, for example. When a diagnostics result is normal, ‘GOOD’ or ‘Normal’, for example is displayed. The display portion G13 displays the state of each disk drive 231 that constitutes the volume for each volume of the separation-type storage bay 200. The display portion G14 displays the ID (VOL ID) of each volume, the volume size (SIZE), access state (AS), volume status (BS), and backup time (TIME) and so forth. The display portion G15 displays a graphics display of an aspect of each disk drive 231 mounted in the separation-type storage bay 200. Here, a disk drive 231 in which an anomaly or the like has been detected is displayed so that same can be distinguished from a normal drive. The display portion G16 displays the state of each disk drive 231, the state of the drive control portion (CTL) 220 and the state of the power supply control portion (PS) 225.

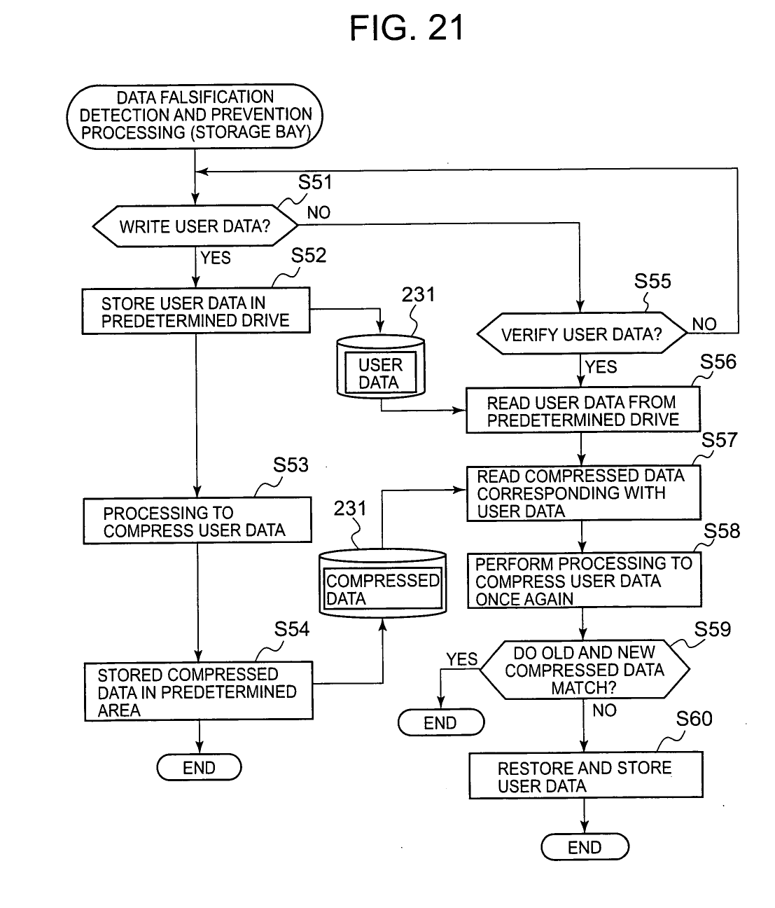

FIG. 21 is a flowchart showing processing to judge whether data written to the volume 232 of the separation-type storage bay 200 has been falsified. In order to detect the existence of data falsification, in this example, compressed data of the written data is generated and the data read from the volume is compared with compressed data. This processing can be executed in the separation-type storage bay 200 or can be executed through cooperation between the controller 120 of the device main body 110 and the controller function of the separation-type storage bay 200. In the following description, a case where processing is executed by means of the separation-type storage bay 200 will be described.

When user data is written to the volume 232 in the separation-type storage bay 200 (S51:YES), the separation-type storage bay 200 writes user data to a predetermined disk drive 231 (S52). A predetermined disk drive 231 signifies a disk drive that corresponds with a designated writing destination address.

Thereafter, the separation-type storage bay 200 generates compressed data by subjecting user data to compression processing (S53) and stores the compressed data in a specified storage area (S54). A storage area or the like of a specified disk drive 231 can be used, for example, as the specified storage area.

When the reliability of the user data is verified (S51:NO, S55:YES), the separation-type storage bay 200 reads user data to be verified from the disk drive 231 (S56) and reads compressed data calculated for the user data from a disk drive 231 that is the same or different (S57).

Further, the separation-type storage bay 200 generates compressed data once again by re-compressing the user data thus read (S58). The compressed data calculated once again is known as new compressed data hereinbelow and the compressed data that is calculated when user data is written is known as the old compressed data.

The separation-type storage bay 200 compares the old and new compressed data and judges whether the old and new compressed data match (S59). When there is a match between the old compressed data and the new compressed data (S59:YES), user data is not falsified and therefore this processing ends. Conversely, when there is no match between the new compressed data and old compressed data (S59:NO), because this represents a case where the user data has been falsified, the separation-type storage bay 200 restores the user data on the basis of the old compressed data and parity data and stores the restored data in a predetermined disk drive 231 (S60).

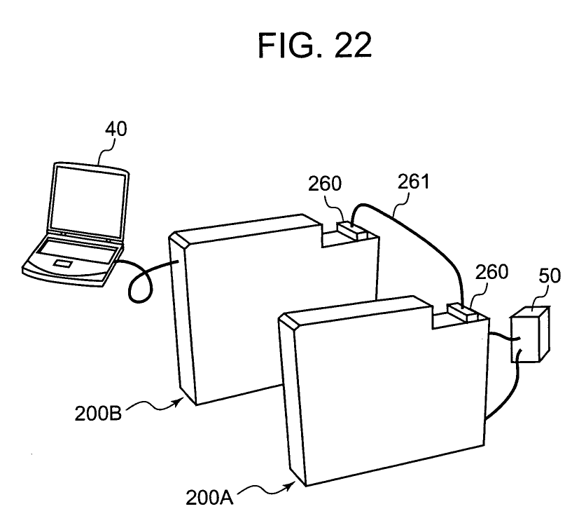

Thereafter, FIG. 22 is a schematic diagram that shows an aspect in which data is copied between two separation-type storage bays 200. When data is copied between a plurality of separation-type storage bays 200, the user connects connectors 260 of the respective separation-type storage bays 200 by means of a cable 261, connects the external power supply 50 to the respective separation-type storage bays 200, and connects the management terminal 40 to one or both separation-type storage bays 200. Although FIG. 22 shows a case where a management terminal 40 is connected to only one separation-type storage bay 200, a configuration in which the management terminal 40 is connected to both storage bays 200 is also possible. When the management terminal 40 is connected to only either one of the separation-type storage bays 200, the connected separation-type storage bay 200 may be configured to interrupt the data exchange between the other separation-type storage bay 200 and the management terminal 40.

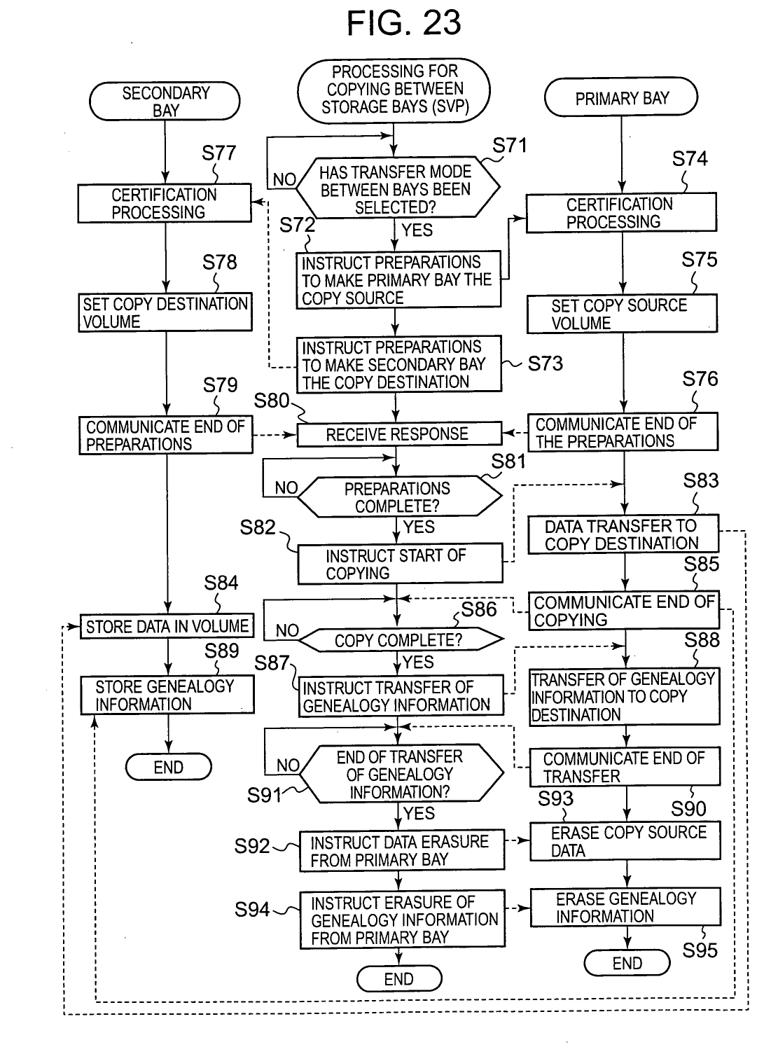

FIG. 23 is a flowchart showing processing in which the separation-type storage bays 200 transfer data directly without the involvement of the device main body 110. The user is able to select an inter-storage bay transfer mode from the management terminal 40 (S71). Here, the user is able to designate the range of the transferred data.

When the inter-storage bay transfer mode is selected (S71:YES), the management terminal 40 communicates the volume ID and so forth selected for the copy source volume to the separation-type storage bay (also known as the ‘primary bay’ hereinbelow) 200, which constitutes the copy source and issues an instruction for copy source preparations to be performed (S72). Similarly, the management terminal 40 communicates the ID and volume size and so forth of the copy source volume to the separation-type storage bay (also known as the ‘secondary bay’ hereinbelow) 200, which constitutes the copy destination and issues an instruction for copy destination preparations to be performed (S73).

Upon receipt of an instruction from the management terminal 40, the primary bay performs certification processing by requesting the input of a user ID and password, for example (S74). When it is confirmed that the user is a valid user, the primary bay sets the designated logical volume as the copy source volume (S75) and communicates the fact that preparations are complete to the management terminal 40 (S76). Similarly, upon receiving an instruction from the management terminal 40, the secondary bay also performs certification processing (S77) before setting the copy destination volume (S78) and reporting the end of preparations (S79). Further, when certification fails, error processing is performed and a data transfer between the separation-type storage bays 200 is not performed.

The management terminal 40 receives the preparation end report (S80) and, when the preparations for each storage bay 200 are complete (S81:YES), issues an instruction to start copying to the primary bay (S82). Upon receipt of the instruction from the management terminal 40, the primary bay transfers data to the secondary bay (S83). The secondary bay receives data and stores same in the copy destination volume (S84).

When the data transfer is complete, the primary bay communicates the fact that data copying is complete to the management terminal 40 (S85). Further, although not illustrated, the secondary bay is also able to communicate the fact that data copying is complete to the management terminal 40.

Upon confirming that data copying is complete (S86:YES), the management terminal 40 issues an instruction to transfer the genealogy information D10 to the primary bay (S87). The primary bay transfers the genealogy information D10 to the secondary bay (S88). The secondary bay receives the genealogy information D10 and stores same in the nonvolatile memory 222 (S89). The primary bay communicates the fact that the transfer of the genealogy information D10 is complete to the management terminal 40 (S90) Further, the secondary bay may also transfer a report to the effect that storage of the genealogy information D10 is complete to the management terminal 40.

Upon confirming that the genealogy information D10 has been transferred (S91:YES), the management terminal 40 orders the primary bay to perform data erasure (S92). Further, the management terminal 40 orders the primary bay to erase the genealogy information D10 (S93). The primary bay erases data that is stored in the logical volume 232 and genealogy information that is stored in the nonvolatile memory 222 in accordance with the erasure instruction from the management terminal 40 (S93, S95).

Thus, in this example, a data transfer can be performed directly between a plurality of separation-type storage bays 200 without going via the device main body 110. Therefore, for example, stored content in the separation-type storage bay 200 that has been stored for a long time can be moved simply to a new separation-type storage bay 200.

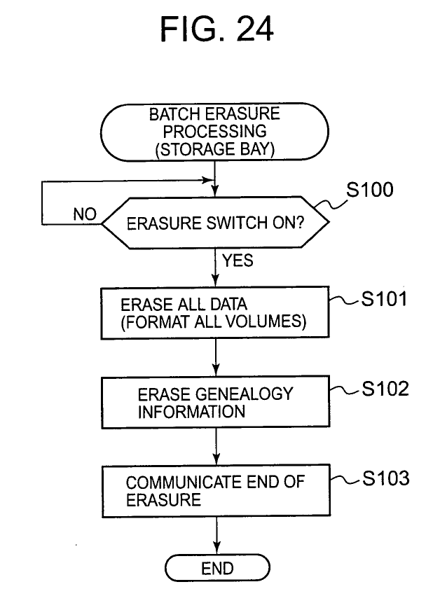

FIG. 24 is a flowchart showing processing to erase all the stored content of the separation-type storage bay 200 batchwise without using the management terminal 40. The user is able to instruct the separation-type storage bay 200 to erase all the stored content by operating the operating switch portion 250 (S100). For example, an erasure command button may be provided on the operating switch portion 250 or the configuration may be such that an erasure command is issued by operating another button such as a power supply switch in a predetermined pattern.

When erasure is instructed by means of a user manual operation (S100:YES), the drive control portion 220 formats each disk drive 231 and erases all the data stored in each disk drive 231 (S101) Thereafter, the drive control portion 220 erases the genealogy information D10 that is stored in the nonvolatile memory 222 (S102). Further, the drive control portion 220 communicates the fact that the erasure of stored content is complete to the user via the indicator 240 (S103). For example, by causing an LED lamp to light up in a predetermined pattern that is set beforehand or by displaying a message to the effect that erasure is complete on a display, the completion of the erasure operation can be communicated to the user.

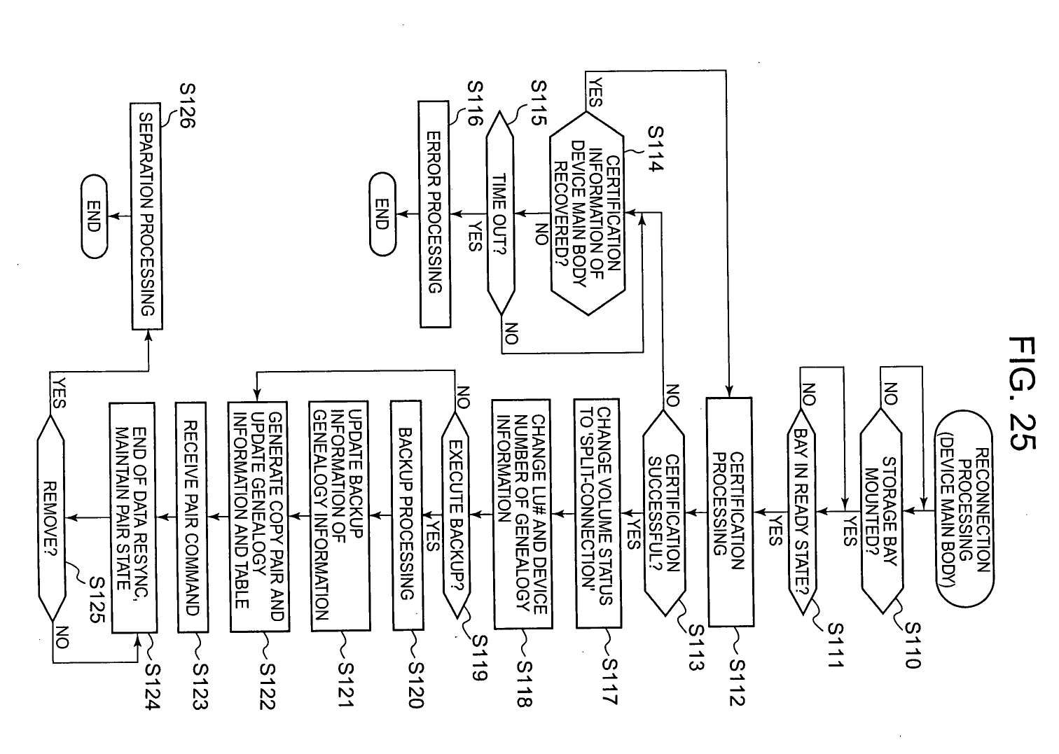

FIG. 25 is a flowchart showing processing when the separation-type storage bay 200 is remounted on the device main body 110. The controller 120 of the device main body 110 monitors whether the separation-type storage bay 200 is attached to the bay slot 230 (S110). For example, a contact sensor or noncontact sensor is provided on the underside 111A of the enclosure 111 and the mounting of the separation-type storage bay 200 can be detected on the basis of a sensor signal. Alternatively, the mounting of the separation-type storage bay 200 can be detected on the basis of the conductive state or the like of the respective connectors 160 and 260.

When the mounting of the separation-type storage bay 200 is detected (S110:YES), the controller 120 stands by until the separation-type storage bay 200 is in the ready state (S111). As a result of the supply of power from the device main body 110 to the separation-type storage bay 200, the separation-type storage bay 200 start initialization processing and enters the ready state upon completion of initialization processing.

When the separation-type storage bay 200 enters the ready state (S111:YES), certification processing is started (S112). In the certification processing, certification information is input from the controller 120 to the separation-type storage bay 200. Certification information such as a user ID and password is stored in addition to genealogy information D10 in the nonvolatile memory 222 of the separation-type storage bay 200. The certification information can be registered and changed by the management terminal 40, for example. Certification information is also registered in the local memory 125, for example, by the controller 120.

The controller 120 judges whether certification has been successful (S113). When certification has failed (S113:NO), it is judged whether certification information on the side of the device main body 110 has been recovered (S114). When there is a mismatch between certification information on the side of the device main body 110, that is, in the controller 120, and certification information in the separation-type storage bay 200, certification information in the controller 120 is manually or automatically recovered. For example, the certification information in the controller 120 can be re-registered by an operation by the user. Alternatively, certification information in the local memory 125 can also be updated on the basis of master data that is encoded and stored in the built-in storage bay 130.

The controller 120 judges whether certification information in the controller 120 has been recovered in a predetermined time that is set beforehand (S114). When certification information in the controller 120 has been recovered (S114:YES), the processing returns to S112. When certification information has not been recovered in the predetermined time (S114:NO), error processing is performed (S116). In this error processing, for example, the occurrence of an error can be communicated to the outside via a display that is provided on the device main body 110, the indicator portion 240 of the separation-type storage bay 200 or the screen of the management terminal 40.

On the other hand, when certification is successful (S113:YES), the controller 120 updates the volume status of the logical volume 232 in the separation-type storage bay 200 to ‘split-connection’ (S117). Further, the controller 120 reads genealogy information from the separation-type storage bay 200 and updates the logical address, physical address, and device number and so forth (S118). That is, the in-device logical address (LU#), device number and physical address (PA#) is rewritten by the controller 120. This information is rewritten so that the controller 120 conforms to the existing configuration of on the device main body 110.

When the storage control device 100 to which the separation-type storage bay 200 is attached is a backup storage control device, that is, in the case of the storage control device 100 to which the backup device 30 is connected, it is judged whether to execute backup processing (S119). When the start of backup processing is instructed by the user (S119:YES), the controller 120 reads data from the separation-type storage bay 200 and stores the data in the backup device 30 (S120). The controller 120 then updates the backup information in the genealogy information D40 (S121). When backup processing is not performed (S119:NO), S120 and S121 are skipped and processing moves to S122.

The controller 120 then generates a copy pair by means of the logical volume 132 in the built-in storage bay 130 and the logical volume 232 in the separation-type storage bay 200 and updates the genealogy information D40 and LU management table D30 (S122). The controller 120 then starts resync processing upon receiving a pair command (S123) and holds a pair state after synchronizing the data of the regular and duplicate volumes (S124).

When the removal of the separation-type storage bay 200 is instructed by the user (S125:YES), the controller 120 executes the above storage bay separation processing (S126). When the removal of the separation-type storage bay 200 is not instructed (S125:NO), the controller 120 returns to S124 and retains the pair state.

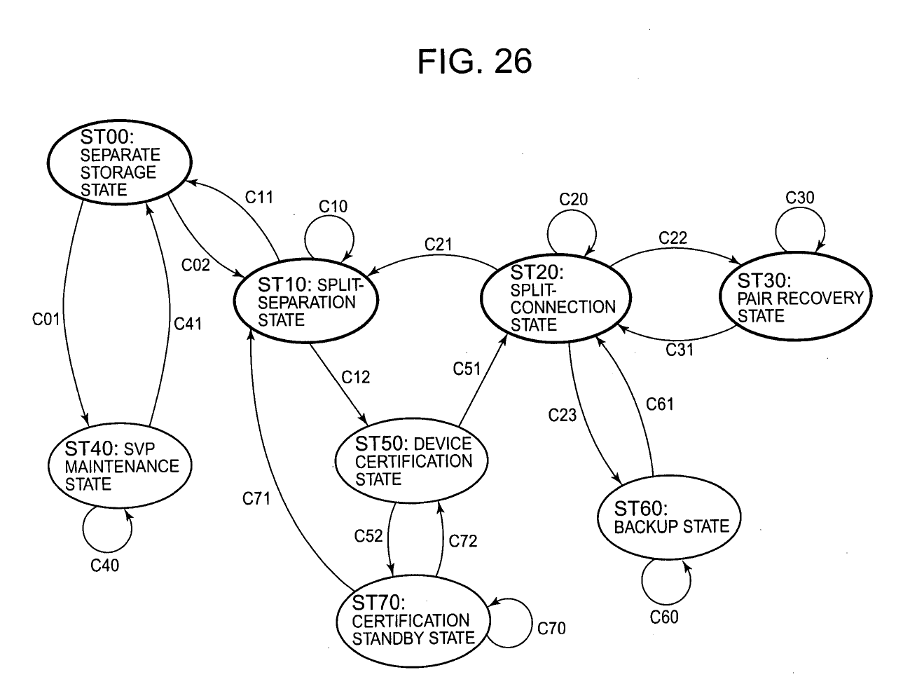

FIG. 26 is a state transition diagram of the separation-type storage bay 200. When the separation-type storage bay 200 is removed from the device main body 110, the separation-type storage bay 200 is in the ‘separation storage state’ (ST00). Following this state, when the management terminal 40 and external power supply 50 are each connected to the separation-type storage bay 200 and the user selects the maintenance mode (C01), the separation-type storage bay 200 moves from the ‘separation storage state’ (ST00) to the ‘SVP maintenance state’ (ST40).

The ‘SVP maintenance state’ (ST40) continues while the maintenance processing (self diagnostics processing) is performed (C40) and, when the maintenance processing ends (C41), the separation-type storage bay 200 returns to the ‘separation storage state’ (ST00).

When the separation-type storage bay 200 in the ‘separation storage state’ (ST00) is attached to the device main body 110 and power is supplied to the separation-type storage bay 200 (C02), the separation-type storage bay 200 moves to the ‘split-separation state’ (ST10). The ‘split-separation state’ (ST10) continues until the next instruction is input (C10). When the separation-type storage bay 200 is removed from the device main body 110 and the power supply is stopped (C11), the separation-type storage bay 200 returns to the ‘separation storage state’ (ST00).

When certification information is input (C12) from the device main body 110 to the separation-type storage bay 200 in the ‘split separation state’ (ST10), the separation-type storage bay 200 moves to the ‘device certification state’ (ST50). When certification is successful (C51), the in-device logical address and physical address and so forth are updated and the separation-type storage bay 200 moves to the ‘split-connection state’ (ST20). When certification fails (C52), the separation-type storage bay 200 moves to the ‘certification standby state’ (ST70). The ‘certification standby state’ (ST70) continues either until certification information on the device main body 110 has been recovered or a predetermined time has elapsed (C70). When a time out error has occurred (C71), the separation-type storage bay 200 returns to the ‘split separation state’ (ST10). When certification is successful as a result of recovery (C72), the separation-type storage bay 200 returns to the ‘device certification state’ (ST50).

The ‘split-connection state’ (ST20) is a state where the separation-type storage bay 200 is logically connected to the device main body 110 and the device main body 110 can use the logical volume of the separation-type storage bay 200. This state is continued until the next instruction is issued (C20). In this state, when removal of the separation-type storage bay 200 is instructed (C21), the genealogy information D10 is stored in the separation-type storage bay 200 and the separation-type storage bay 200 returns to the ‘split separation state’ (ST10).

Meanwhile, when a pair command is received (C22), the regular volume in the built-in storage bay 130 and the duplicate volume in the separation-type storage bay 200 are resynchronized and the separation-type storage bay 200 moves to the ‘pair recovery state’ (ST30). The ‘pair recovery state’ (ST30) continues until the next instruction is provided (C30) and, when a split is instructed (C31), the separation-type storage bay 200 returns to the ‘split connection state’ (ST20).

In the ‘split connection state’ (ST20), when the start of backup processing is instructed (C23), the separation-type storage bay 200 returns to the ‘backup state’ (ST60). The ‘backup state’ (ST60) continues until backup processing is complete (C60). When backup processing is complete, backup information in the genealogy information D10 is updated (C61) and the separation-type storage bay 200 returns to the ‘split connection state’ (ST20).

This example is configured as described above and therefore produces the following effects. In this example, a portion of the storage control device 100 is configured as a detachable separation-type storage bay 200. Therefore, the separation-type storage bay 200 can be configured relatively small and lightweight and the separation-type storage bay 200 alone can be removed from the storage control device 100 and transported to another location, whereby user convenience improves.

In this example, the configuration is such that a plurality of disk drives 231 is provided in the form of an array in the separation-type storage bay 200. Therefore, data stored in each disk drive 231 can be moved altogether and, by transporting the separation-type storage bay 200, a large volume of data can be used at the transportation destination, whereby user convenience improves.

In this example, a plurality of disk drives 231 are provided in the separation-type storage bay 200 and a redundant configuration is adopted in path switching and so forth. Therefore, a large amount of data can be stored highly reliably.

In this example, the configuration is such that the built-in storage bay 130 is provided in the device main body 110 and data can be copied between the respective storage bays 130 and 200. Therefore, by copying data stored in the built-in storage bay 130 to the separation-type storage bay 200, a backup can be made relatively simply and at high speed, whereby user convenience improves. Further, by remounting the separation-type storage bay 200 for storing the backup data in the device main body 110, the separation-type storage bay 200 can be restored relatively simply and at high speed, whereby user convenience improves.

In this example, a configuration that makes it possible to generate a plurality of logical volumes 232 in the separation-type storage bay 200 is implemented. Therefore, backup data of respectively different regular volumes can be stored or backup data of different generations can be stored for the same regular volume, whereby user convenience improves.

In this example, backup data can be stored and transported in the separation-type storage bay 200. Therefore, the separation-type storage bay 200 can be transported to a backup site that is physically separate from the primary site and, by only copying data to another storage control device 100 that is provided at the backup site, an initial copy can be completed. As a result, initial construction of the backup site can be performed relatively simply and at low cost without using a communication network, whereby user convenience improves.

In this example, the configuration is such that the separation-type storage bay 200 is provided with a self diagnostics function. Therefore, in a situation where the separation-type storage bay 200 has been removed from the device main body 110, the state and so forth of the disk drive 231 can be tested without involving the device main body 110, whereby user convenience improves.

In this example, the configuration provides a function for detecting data falsification and automatically restoring falsified data. As a result, the incorrect rewriting of data stored in a stored separation-type storage bay 200 can be prevented, whereby reliability and stability improve.

In this example, the configuration is such that it is possible to set a read-only access attribute for the logical volume 232 in the separation-type storage bay 200. Therefore, a situation where a third party rewrites data that is stored in the stored separation-type storage bay 200 can be suppressed.

In this example, the configuration is such that the separation-type storage bays 200 are able to transfer data directly. Therefore, for example, data can be moved relatively simply without involving the device main body 110 from a separation-type storage bay 200 that has been held for a long time whose lifespan is reduced to a new separation-type storage bay 200, for example, whereby user convenience improves.

In this example, the configuration is such that, when a data transfer between separation-type storage bays 200 is complete, data and genealogy information D10 stored by the movement-source separation-type storage bay 200 is automatically erased. Therefore, for example, even when the movement-source separation-type storage bay 200 is removed by a third party, a situation where stored content is leaked to the third party can be prevented. Further, because the separation-type storage bay 200 from which stored content has been erased is reusable, the running costs of the storage system can be reduced and user convenience improves.

In this example, the configuration is such that all the stored content in the separation-type storage bay 200 can be erased altogether by means of a manual operation. Therefore, the separation-type storage bay 200 can be initialized relatively simply without connecting the management terminal 40, whereby user convenience improves.

In this example, the configuration is such that the respective processing is executed only when the separation-type storage bay 200 is connected to the device main body 110, when data stored in the separation-type storage bay 200 is erased, when data is transferred to another separation-type storage bay 200, and when certification processing is performed and certification is successful. Therefore, incorrect usage of the separation-type storage bay 200 by a third party can be suppressed and reliability can be improved.

### EXAMPLE 2

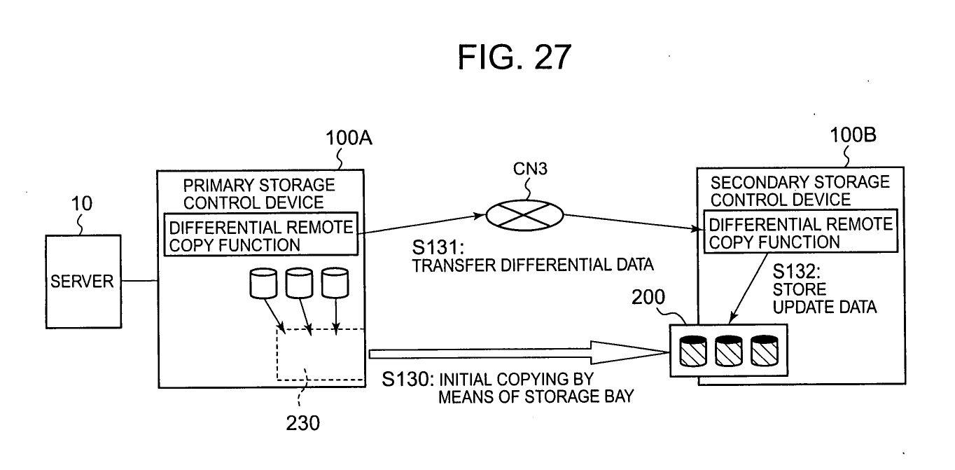

A second example will be described on the basis of FIG. 27. In this example, after initial construction at the backup site is complete, update data issued by the primary site is transferred to the backup site via a communication network CN3.

FIG. 27 is an explanatory view of the overall configuration of the storage system of this example. A primary storage control device 100A is installed at the primary site. Backup data of a regular volume that the primary storage control device 100A comprises is copied to the separation-type storage bay 200. The separation-type storage bay 200 storing the backup data is introduced to the backup site.

A secondary storage control device 100B is provided at the backup site. The separation-type storage bay 200 is attached to the secondary storage control device 100B and backup data in the separation-type storage bay 200 is copied to the regular volume in the secondary storage control device 100B. As a result, the initial construction of the backup site ends (S130).

At the primary site, differential data that differs from the backup data is produced as a result of the server 10 accessing the regular volume. The differential data is transmitted from the primary storage control device 100A to the secondary storage control device 100B via the communication network CN3. Upon receipt of the differential data, the secondary storage control device 100B reflects the differential data in the regular volume. As a result, the stored content of the primary storage control device 100A and secondary storage control device 100B is synchronized.

Further, the present invention is not limited to the above embodiments. The person skilled in the art is able to perform a variety of additions and modifications within the scope of the invention. For example, although a SAN and LAN are exemplified as communication protocols, the communication protocol is not limited to same. For example, the present invention can also be applied to another protocol such as iSCSI, ESCON (registered trademark), FICON (registered trademark).

Further, although a case where physical addresses are managed in disk drive units in the separation-type storage bay was described in this embodiment, the present invention is not limited to such a case and physical addresses can also be managed in block units. In addition, by providing a file management system in the separation-type storage bay, for example, physical addresses can also be managed in file units. That is, a NAS (Network Attached Storage) function can also be mounted in the separation-type storage bay 200.

Moreover, in addition to monitoring systems, the present invention can also be widely applied to data management systems and storage systems and so forth in households and enterprises and the like, for example.

What is claimed is:

1. A storage control device comprising a device main body connected to an external device and a storage device provided in the device main body, wherein the storage device is configured as a separation-type storage device that is detachably attached to the device main body,
wherein (1) the device main body comprises:
a first control portion for controlling the exchange of data between the storage device and the external device;
a first memory portion that is used by the first control portion and which stores management information for managing the storage device; and
a first connection portion for a connection with the separation-type storage device; and
(2) the separation-type storage device comprises:
a plurality of storage drives;
a second control portion that controls the exchange of data between each of the storage drives;
a second memory portion that is used by the second control portion and which stores the management information; and
a second connection portion for a connection with the device main body via the first connection portion.

2. The storage control device according to claim 1, wherein the management information includes configuration information relating to each of the storage drives and configuration information relating to a logical volume that is generated on the basis of each storage area of each of the storage drives.

3. The storage control device according to claim 1, wherein at least a portion of the management information stored in the second memory portion is rewritten by the first control portion in both a case where the separation-type storage device is removed from the device main body and a case where the separation-type storage device is attached to the device main body.

4. The storage control device according to claim 1, wherein, when the separation-type storage device is attached to the device main body, the first control portion resets identification information for identifying each of the storage devices and identification information for identifying a logical volume that is generated on the basis of the respective storage areas of each of the storage devices, and rewrites the management information stored in the first memory portion and the second memory portion.

5. The storage control device according to claim 2, wherein the management information includes access control information for controlling access to the logical volume.

6. The storage control device according to claim 5, wherein the access control information is set to prohibit writing to the logical volume.

7. The storage control device according to claim 1, wherein the device main body comprises a built-in storage device that differs from the separation-type storage device and the built-in storage device and the separation-type storage device are associated by means of the management information.

8. The storage control device according to claim 1, wherein the device main body comprises another logical volume that differs from the logical volume that the separation-type storage device comprises;
the logical volume of the separation-type storage device and the other logical volume are associated by means of the management information; and
the first control portion is able to move data between each of the logical volumes.

9. The storage control device according to claim 8, wherein the first control portion is able to perform volume copying with the other logical volume serving as the copy source volume and the logical volume of the separation-type storage device serving as the copy destination volume; and
the management information includes generation management information for managing the generation of data that is stored in the logical volume of the separation-type storage device.

10. The storage control device according to claim 1, wherein the management information includes volume status information indicating the status of the logical volume; and
the volume status information includes a first split state that indicates a split state in a case where the separation-type storage device and the device main body are physically connected and a second split state that indicates a split state in a case where the physical connection between the separation-type storage device and the device main body is cancelled.

11. The storage control device according to claim 1, wherein the separation-type storage device comprises:
a self diagnostics portion for diagnosis of the state of each of the storage drives; and
a third connection portion for a connection with an instruction device, wherein the self diagnostics portion diagnoses the state of each of the storage drives on the basis of an instruction from the instruction device.

12. The storage control device according to claim 11, wherein the self diagnostics portion generates and stores compression information for the data that is written from the first control portion to each of the storage drives via the second control portion, and verifies the reliability of the data by comparing the compression information that is generated once again from the data stored in each of the storage drives with the stored compression information.

13. The storage control device according to claim 1, wherein the separation-type storage device comprises a user interface portion and the separation-type storage device is able to execute control operations of a plurality of types on the basis of an instruction from the user interface portion.

14. The storage control device according to claim 1, wherein the separation-type storage device comprises a third connection portion that can be connected directly to another separation-type storage device via the second connection portion without involving the device main body and which allows a connection with an instruction device; and the second control portion erases data that is stored in each of the storage drives and the management information that is stored in the second memory portion on the basis of an instruction from the instruction device.

15. The storage control device according to claim 1, wherein the separation-type storage device comprises a third connection portion that can be connected directly to another separation-type storage device without involving the device main body and which allows a connection with an instruction device, and
the second control portion transfers data stored in each of the storage drives to the other separation-type storage device and causes the other separation-type storage device to store the data on the basis of an instruction from the instruction device.

16. The storage control device according to claim 14, wherein, upon receiving an instruction from the instruction device, the second control portion requests predetermined certification information from the instruction device and performs processing based on the instruction only when certification is successful.

17. The storage control device according to claim 1, wherein the external device is at least one of a higher order device that reads and writes data to each of the storage drives or a backup device that stores data stored in each of the storage drives.

18. A separation-type storage device that is detachably attached to a storage control device connected to an external device, comprising:
an enclosure;
a plurality of storage drives provided in the enclosure;
a second connection portion for a connection to the storage control device via a first connection portion that is provided in the device main body of the storage control device;
a second control portion that is connected via the first and second connection portions to a first control portion provided in the device main body and which controls the exchange of data between each of the storage drives; and
a second memory portion that stores management information for managing each of the storage drives.

19. The separation-type storage device according to claim 17, further comprising:
a third connection portion for a direct connection with an instruction device, wherein the second control portion executes a predetermined control operation on the basis of an instruction that is input from the instruction device via the third connection portion.

20. The separation-type storage device according to claim 18, wherein the predetermined control operation includes an erasure operation for erasing data that is stored in each of the storage drives and the management information that is stored in the second memory portion, and an output operation that outputs data stored in each of the storage drives to the outside.
